(19) United States
(12) Patent Application Publication
(10) Pub. No.: US 2012/0024769 A1
(43) Pub. Date: Feb. 2, 2012

(54) METHOD FOR COLLECTING MATTER WITH A MATTER COLLECTION UNIT

(75) Inventors: Jonathan E. Martin, London, OH (US); Joel W. Quinn, Xenia, OH (US); Shanon Rogers, Grandview, OH (US)

(73) Assignee: ALGAEVENTURE SYSTEMS, INC., Marysville, OH (US)

(21) Appl. No.: 13/269,173

(22) Filed: Oct. 7, 2011

Related U.S. Application Data
(63) Continuation-in-part of application No. PCT/US2011/040804, filed on Jun. 17, 2011.
Application No. PCT/US2011/040804 is a continuation-in-part of application No. PCT/US2011/040808, filed on Jun. 17, 2011.
(60) Provisional application No. 61/355,969, filed on Jun. 17, 2010.
(60) Provisional application No. 61/355,990, filed on Jun. 17, 2010.
(60) Provisional application No. 61/355,969, filed on Jun. 17, 2010.
(60) Provisional application No. 61/355,990, filed on Jun. 17, 2010.

(51) Int. Cl. C02F 1/00; B01D 37/00

(52) U.S. Cl. 210/198.1; 210/767; 210/500.1

(57) ABSTRACT

A method for collecting matter using a matter collection Unit, as described below, provides a low energy, low cost and nearly zero pollutant process for extracting suspended and/or dissolved matter in a medium. The method collects the matter on a material when the medium is permitted to flow past the material which is disposed within a chamber, and the medium, with less suspended matter, can flow back to a medium body to permit, e.g., further growth and/or higher collection efficiency. The process can operate continuously alongside, e.g. a growth system, to harvest suspended matter until the matter is ready for extraction. Post extraction collected matter, e.g., can be converted into valuable commercial products or the process can be used to remediate a medium, such that the valuable product is a substantially cleaner medium.

### CROSS-REFERENCE TO RELATED APPLICATIONS

This application is a continuation in part of and claims priority to (1) PCT/US2011/040804 filed on Jun. 17, 2011 naming inventors Youngs, Cook and Rogers claiming priority to U.S. Provisional Patent Applications 61/355,990 and 61/355,969 filed on Jun. 17, 2010 naming inventors Youngs and Cook, and (2) PCT/US2011/040808 filed on Jun. 17, 2011 naming inventors Youngs, Cook and Rogers claiming priority to U.S. Provisional Patent Applications 61/355,990 and 61/355,969 filed on Jun. 17, 2010 naming inventors Youngs and Cook; the contents of all aforementioned Applications are incorporated by reference as if fully reproduced below.

### STATEMENT REGARDING FEDERALLY-SPONSORED R & D

The present invention was made with government support under DE-AR0000037 awarded by the Department of Energy. The government has certain rights in the invention under 35 U.S.C. §200 et seq.

### BACKGROUND

Collecting matter in a medium, e.g. algae in water, is an expensive process which usually damages the matter structurally or contaminates the matter so as to make it less usable for downstream commercial products, e.g. biofuels, pharmaceuticals, nutraceuticals and cosmetics. Information relevant to attempts to address these problems can be found in the following: (1) U.S. Pat. No. 6,572,770; (2) U.S. Pat. No. 5,715,774; (3) US 2010/0105125; (4) US 2010/0210003; (5) US 2011/0016773; (6) US 2009/0203115; (7) US 2010/0144017; (8) US 2010/0267122; (9) US 2011/0065165; (10) EP 942,646; (11) WO 2011038413; (12) WO 9851627; (13) US 20100105125; (14) WO 2010151887; (15) U.S. Pat. No. 3,917,528; (16) U.S. Pat. No. 4,172,039; (17) U.S. Pat. No. 5,259,958; (18) U.S. Pat. No. 6,732,499; (19) U.S. Pat. No. 6,572,770; (20) U.S. Pat. No. 6,393,812; (21) The Basics of Oil Spill Cleanup by Mery Fingas, ISBN 9781566705370, CRC Press, Sept. 28, 2000; (22) WO 9501308; (23) U.S. Pat. No. 4,575,426; (24) JP 11333211; (25) WO 2009119396; (26) U.S. Pat. No. 7,922,900; (27) U.S. Pat. No. 7,635,587; (28) EP 1,725,314; (29) US 2010/0311157; (30) WO 2009056899; and, (31) WO 2011098076. The listing of the preceding documents is not an admission of the documents either as prior art against the present invention or as analogous art. The citation of any publication is for its disclosure prior to the filing date and should not be construed as an admission that the present invention is not entitled to antedate such publication by virtue of prior disclosure and/or prior invention.

Each of the listed documents, and the disclosed methods and apparatuses therein, suffers from at least one of the following disadvantages: (1) they require the use of expensive chemicals; (2) they require the use of chemicals which contaminate collected matter; (3) they require the use of high-energy machines; (4) they require the use of expensive machines; (5) they compromise the collected matter's structural and/or chemical integrity; (6) they require constant supervision by an operator; (7) they require continued replacement of collection and/or concentration parts; (8) they have a high initial capital cost barrier, and thus a disincentive, for market entry; (9) they raise the cost of downstream products and processes; (10) they are not modular bolt on options for any artificial or natural growth systems; (11) they are dependent on the size of the growth system; (12) they are limited by algal growth rates; (13) they have inefficient material removal methods; (14) they do not capture loosely associated matter; (15) they are invasive of a growth system and can contaminate axenic growth systems; and, (16) they block light to the growth system and inhibit algal development. Examples of methods and apparatuses which suffer from these disadvantages comprise centrifuges, hollow fiber filters, cross flow filters, tangential flow filters, bubblers, flocculaters, porous filters and film growers.

Extracting a suspended solid from a liquid medium using the known prior art methods and apparatuses is an expensive process that makes an entire industry of collection and concentration economically and environmentally unsound. Discovering a low cost and environmentally friendly solution to collecting and/or concentrating, e.g., algae in water could allow entire industries that derive, inter alia, biofuels, pharmaceuticals, nutraceuticals and cosmetics from harvested algae to become economically viable, and leaders of those industries can begin to fuel, feed and heal a twenty first century population. A device as described in the following detailed description provides advantages over the known attempts.

### SUMMARY

The present invention is directed to a method, apparatus and system that satisfies a need for a modular process for collecting matter in a liquid medium that is low capital and operational cost, contaminant free and non-damaging. This and other unmet advantages are provided by the invention as described and shown in more detail below.

### BRIEF DESCRIPTION OF THE DRAWINGS

A better understanding of the disclosed embodiments will be obtained from a reading of the following detailed description and the accompanying drawings:

FIG. 1 is perspective view of matter collection Unit comprising an inlet tube, a chamber, a cartridge, a base, an outlet tube and an extractor;

FIG. 2 is perspective view of material comprising cut fibers and a first surface;

FIG. 3 is perspective view of material comprising looped fibers and a first surface;

FIG. 4 is perspective view of material comprising cut fibers, a second surface and a reinforcing surface;

FIG. 5 is perspective view of material comprising looped fibers, second surface, and reinforcing surface;

FIG. 6a is a view of cut fibers;

FIG. 6b is a view of cut fibers;

FIG. 6c is a view of cut fibers and a first surface;

FIG. 7a is a zoom view of material comprising cut fibers, looped fibers and a first surface;

FIG. 7b is a zoom view of material comprising looped fibers, a second surface and a reinforcement fiber;

FIG. 7c is a zoom view of material comprising looped fibers, a second surface, a first surface and a reinforcement fiber;

FIG. 7d is a zoom view of material comprising looped fibers, a second surface, a first surface and a reinforcement fiber;

FIG. 8a is a view of cut fibers;

FIG. 8b is a view of cut fibers and a first surface;

FIG. 8c is a view of cut fibers and a first surface;

FIG. 9 is a view of geometric shapes which can define a cross section of material;

FIG. 10 is a view of geometric shapes which can define a cross section of a cartridge formed from planar material;

FIG. 11a is a view of algae attached to a fiber;

FIG. 11b is a view of oil among fibers;

FIG. 11c is a view of algae attached to a fiber;

FIG. 11d is a view of algae attached to a fiber;

FIG. 11e is a view of algae attached to a fiber;

FIG. 11f is a view of algae attached to a fiber;

FIG. 12 is a perspective view of a matter collection Unit comprising an inlet port, a chamber, a cartridge and an outlet port;

FIG. 13 is a cross sectional view of a matter collection Unit comprising an inlet port, a chamber, a cartridge and an outlet port;

FIG. 14 is a cross sectional view of a matter collection Unit comprising an inlet tube, an inlet valve, an inlet port, a chamber, a cartridge, a screen, a base, an outlet port, an outlet tube, an outlet valve, a pressure plate, a connection member and an action plate;

FIG. 15 is a cross sectional view of a matter collection Unit comprising a chamber, a screen, a base and an outlet port;

FIG. 16 is a cross sectional view of a matter collection Unit comprising an inlet tube, an inlet valve, an inlet port, a chamber, a cartridge, a duct, a bubbler, bubbles, flow direction, a screen, a base, an outlet port, an outlet tube and an outlet valve;

FIG. 17 is a cross sectional view of a matter collection Unit comprising a chamber, a duct, a bubbler, a screen, a base, an outlet port and an outlet tube;

FIG. 18 is a cross sectional view of a matter collection Unit comprising an inlet tube, an inlet valve, an inlet port, a chamber, a cartridge, a screen, a base, an outlet port, an outlet tube, an outlet valve, a pressure plate, a connection member, an action plate, a first position, a second position and a medium level; and,

FIG. 19 is a perspective view of a matter collection Unit adapted to a medium body.

### DETAILED DESCRIPTION

Prior to describing the various embodiments, the following definitions are provided and should be used unless otherwise indicated.

### DEFINITIONS

In describing the disclosed subject matter, the following terminology will be used in accordance with the definitions set forth below.

“Comprising” is an open ended transition word that, when preceding a list or description, connotes that the following list or description does not fully list or describe all possibilities; therefore, the list or description can contain additional elements not listed or described.

“Consisting” is a close ended transition word that when preceding a list or description the word connotes that the following list or description is complete.

A “medium” is any environment which is predominantly liquid wherein solids and/or chemicals may exist in the medium in suspension, dispersion or solution. Medium refers to aqueous and non-aqueous mediums equally.

An “aqueous medium” is a medium which is predominantly comprised of liquid water, and the water is at least one selected from the group comprised of fresh water, brackish water, salt water, marine water, briny water, commercial waste water, residential waste water and agricultural waste water. A “non-aqueous medium” is predominantly comprised of a non-water liquid, such as oil. A medium can be a combination of aqueous and non-aqueous mediums, i.e. it is difficult to tell what is predominant or localized variations in concentration would lead to differing conclusions. Examples of bodies of mediums, which can be natural or engineered, include rivers, streams, ponds, lakes, oceans, bays, fjords, retaining ponds, settling ponds, raceways, holding tanks, settling tank, photo bio reactors.

“Matter” is a solid and/or chemical suspended, dispersed or dissolved in a medium and at least one selected from the group comprised of algae, oil, bacteria, silt, sand, ethane, hexanol, nitrates, phosphates, benzene, lead, mercury, cadmium, iron, aluminum and arsenic.

“Collection” is a capture of matter on a material, as described below. Collection also includes any matter which is captured by, between or proximate to matter already captured by the material matter can form multiple layers on the material surface, and any subsequent matter layers are considered to be collected though it may not be touching or interlocked with, or in physical or bonded contact with the material. Similar words which are intended to invoke variations of this definition comprise collects, collecting, collected and to collect.

“Collected matter” is any matter that is collected by, between or proximate to a material.

“Material” is any three dimensional object, consistent with its description below, capable of collecting matter in a medium. “Material” is short for “material for collecting matter” in that it is understood to be a material for collecting matter, unless indicated otherwise.

A “chamber” is any three dimensional object capable of retaining a liquid medium substantially without unintended/unwanted leakage and wherein the chamber can be a single piece construction or a construction of several pieces adapted to fit together. A chamber can be sealed at all surfaces, except for at least one port, or a chamber can be open at one or more surfaces, such as a bucket is open on a top or a tube is open at two ends. Such openings would constitute ports for purposes of this specification. Example shapes of a chamber comprise a barrel, box, trough, tube, etc.

A “duct” is any three dimensional object capable of permitting a flow of medium through itself while maintaining at least a partial physical barrier within a given space.

A “valve” is any device for halting or controlling the flow of medium a chamber, duct, tube, inlet or outlet. The valve can open, close or partially obstruct the passageways, and the valves can be manually, mechanically, electrically, hydraulically, pneumatically, solenoid or motor operated. Examples of acceptable valves comprise the following: ball valve; butterfly valve; ceramic disc valve; choke valve; diaphragm valve; gate valve; stainless steel gate valve; globe valve; knife valve; needle valve; pinch valve; piston valve; plug valve; poppet valve; spool valve; thermal expansion valve; and sampling valve.

An “extractor” is any device, consistent with its description below, that removes collected matter from a material. The extractor can be manually, mechanically, electrically, hydraulically, pneumatically, solenoid, electro-mechanically or motor operated. An extractor is at least one selected from the group comprising a plunger, a piston, a screen, an orifice, a belt roller, a nested roller, a funnel, a vacuum, a scraper, an electric charge, an air knife, a spinner, a sonicator, a vibrator, a human hand, a heater, a steamer and a low-volume high pressure sprayer. Similar words which are intended to invoke variations of this definition comprise extraction, extracting, to extract and extracts.

“Extracted matter” is any matter that is formerly collected matter due to an extractor or extraction process. The extracted matter will be a combination of formerly suspended and/or dissolved matter and the medium in which the matter was suspended and/or dissolved.

A “container” is any device which is capable of retaining/storing, for any amount of time, collected matter while segregating the collected matter from a medium. Examples of containers are barrels, boxes, troughs, hoppers, tubes, pipes, trays, buckets and bladders. The collected matter can flow to the container in any number of ways, including by gravity, by pump, by conveyor, or by another container such as a pipe or bucket, or by operating valves or solenoids.

A “dwell time” or a “dwell period” is a duration that a medium is permitted to reside within and/or flow through a chamber. Collection occurs during the dwell period; however, the material is not necessarily collecting continuously or at a same rate during the dwell period.

“Algae” is plural for any organism with chlorophyll and, in multicellular algae, a thallus not differentiated into roots, stems and leaves, and encompasses prokaryotic and eukaryotic organisms that are photoautotrophic or facultative heterotrophs. The term “algae” includes macroalgae (such as seaweed) and microalgae. For certain embodiments of the disclosure, algae that are not macroalgae are preferred. The term algae used interchangeably herein, refers to any microscopic algae, phytoplankton, photoautotrophic or facultative heterotroph protozoa, photoautotrophic or facultative heterotrophic prokaryotes, and cyanobacteria (commonly referred to as blue-green algae and formerly classified as Cyanophyceae). The use of the term “algal” also relates to microalgae and thus encompasses the meaning of “microalgal.” The term “algal composition” refers to any composition that comprises algae, and is not limited to the body of water or the culture in which the algae are cultivated. An algal composition can be an algal culture, a concentrated algal culture, or a dewatered mass of algae, and can be in a liquid, semi-solid, or solid form. A non-liquid algal composition can be described in terms of moisture level or percentage weight of the solids. An “algal culture” is an algal composition that comprises live algae.

The algae of the disclosure can be naturally occurring species, a selected strain, a genetically manipulated strain, a transgenic strain, or a synthetic alga. Algae from tropical, subtropical, temperate, polar or other climatic regions can be used in the disclosure. Endemic or indigenous algal species are generally preferred over introduced species where an open culturing system is used. Algae, including microalgae, inhabit all types of aquatic environments, including but not limited to freshwater (less than about 0.5 parts per thousand (ppt) salts), brackish (about 0.5 to about 31 ppt salts), marine (about 31 to about 38 ppt salts), and briny (greater than about 38 ppt salts). Any of such aquatic environments, freshwater species, marine species, and/or species that thrive in varying and/or intermediate salinities or nutrient levels, can be used in the embodiments of the disclosure.

In certain embodiments, the algal composition of the disclosure comprises green algae from one or more of the following taxonomic classes: Micromonadophyceae, Charophyceae, Ulvophyceae and Chlorophyceae. Non-limiting examples include species of Borodinella, Chlorella (e.g., C. ellipsoidea), Chlamydomonas, Dunaliella (e.g., D. salina, D. bardawil), Franceia, Haematococcus, Oocystis (e.g., O. parva, O. pustilla), Scenedesmus, Stichococcus, Ankistrodesmus (e.g., A. falcatus), Chlorococcum, Monoraphidium, Nannochloris and Botryococcus (e.g., B. braunii). In certain embodiments, the algal composition of the disclosure comprises golden-brown algae from one or more of the following taxonomic classes: Chrysophyceae and Synurophyceae. Non-limiting examples include Boekelovia species (e.g. B. hooglandii) and Ochromonas species. In certain embodiments, the algal composition in the disclosure comprises freshwater, brackish, or marine diatoms from one or more of the following taxonomic classes: Bacillariophyceae, Coscinodiscophyceae, and Fragilariophyceae. The diatoms can be photoautotrophic or auxotrophic. Non-limiting examples include Achnanthes (e.g., .4. orientalis), Amphora (e.g., Acoffeiformis strains, A. delicatissima), Amphiprora (e.g., A. hyaline), Amphipleura, Chaetoceros (e.g., C. muelleri, C. gracilis), Caloneis, Camphylodiscus, Cyclotella (e.g., C. cryptica, C. meneghiniana), Cricosphaera, Cymbella, Diploneis, Entomoneis, Fragilaria, Hantschia, Gyrosigma, Melosira, Navicula (e.g., N. acceptata, N. biskanterae, N. pseudotenelloides, N. saprophila), Nitzschia (e.g., N. dissipata, N. communis, N. inconspicua, N. pusilla strains, N. microcephala, N. intermedia, N. hantzschiana, N. alexandrina, N. quadrangula), Phaeodactylum (e.g., P. tricornutum), Pleurosigma, Pleurochrysis (e.g., P. carterae, P. dentata), Selenastrum, Surirella and Thalassiosira (e.g., T. weissflogii). In certain embodiments, the algal composition of the disclosure comprises one or more algae from the following groups: Coelastrum, Chlorosarcina, Micractinium, Porphyridium, Nostoc, Closterium, Elakatothrix, Cyanosarcina, Trachelamonas, Kirchneriella, Carteria, Crytomonas, Chlamydamonas, Planktothrix, Anabaena, Hymenomonas, lsochrysis, Pavlova, Monodus, MonaIlanthus, Platymonas, Pyramimonas, Stephanodiscus, Chroococcus, Staurastrum, Netrium, and Tetraselmis, Galdieria and Cyanidium, and any unknown algae having similar genus, family, or orders. In certain embodiments, the algal composition of the disclosure comprises one or more from the following groups: Porphyridium cruentum, Spirulina platensis, Cyclotella nana, Dunaliella salina, Dunaliella bardawil, Muriellopsis spp., Chlorella fusca, Chlorella zofingiensis, Chlorella spp., Haematococcus pluvialis, Chlorococcum citriforme, Neospongiococcum gelatinosum, lsochrysis galbana, Chlorella stigmataphora, Chlorella vulgaris, Chlorella pyrenoidosa, Chlamydomonas mexicana, Scenedesmus obliquus, Scenedesmus braziliensis, Scenedesmus dimorphus, Stichococcus bacillaris, Anabaena flosaquae, Porphyridium aerugineum, Fragilaria sublinearis, Skeletonema costatum, Pavlova gyrens, Monochrysis lutheri, Coccolithus huxleyi, Nitzschia palea, Dunaliella tertiolecta, Prymnesium paruum, and the like. In certain embodiments, the algal composition of the disclosure comprises one or more from the following groups: N. gaditana, N. granulate, N. limnetica, N. oceanica, N. oculata, N. salina. Preferred species of algae comprise Scenedesmus dimorphus, Nanochloropsis, Chlorella and diatoms.

### Overview

A method for collecting matter using a matter collection Unit, as described below, provides a low energy, low cost and nearly zero pollutant process for extracting suspended and/or dissolved matter in a medium. The method collects the matter on a material when the medium is permitted to flow past the material which is disposed within a chamber, and the medium, with less suspended matter, can flow back to a medium body to permit, e.g., further growth and/or higher collection efficiency. The process can operate continuously alongside, e.g. a growth system, to harvest suspended matter until the matter is ready for extraction. Post extraction collected matter, e.g., can be converted into valuable commercial products or the process can be used to remediate a medium, such that the valuable product is a substantially cleaner medium. If the extracted matter is algae, then it can be processed into end user commercial products such as pharmaceuticals, nutraceuticals, cosmetics, biofuels, food products, crop fertilizer, animal feed and polymers. If the extracted matter is oil or bitumen, then it can be recovered at oil spills or in tar sands. If the medium is infected with a harmful algae bloom of cyanobacteria, then the system could not only harvest the algae for processing but also cut off a food source of the algae by additionally extracting suspended silt.

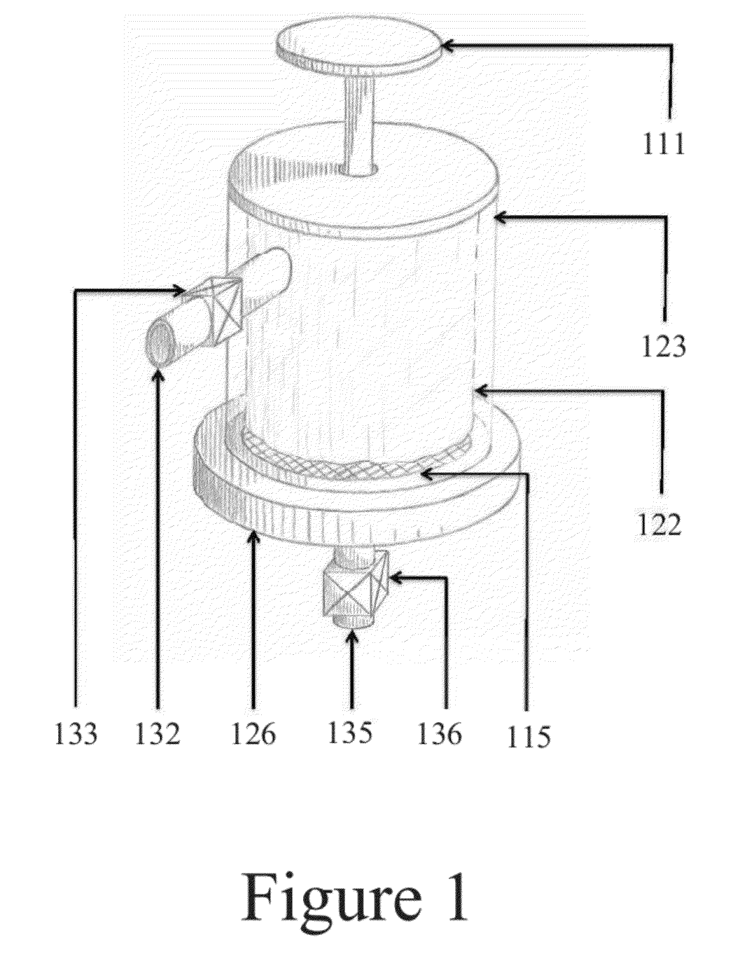

FIG. 1 shows an example embodiment of a matter collection Unit, hereinafter referred to as a Unit, and the Unit is comprised of inlet tube 132, inlet valve 133, chamber 123, cartridge 122, screen 115, base 126, outlet tube 135, outlet valve 136 and extractor 111. A medium flows into the Unit through inlet tube 132, through open inlet valve 133 and into chamber 123 where suspended matter in the medium collects on cartridge 122. The medium flows out of the Unit via outlet tube 135 and through open outlet valve 136. Medium flowing into the Unit has a higher concentration in weight per unit volume of suspended matter than the medium flowing out of the Unit. The differential is caused by suspended matter collecting on cartridge 122 which is formed from a material for collecting matter, as described below. After the medium flow ceases, an optional extractor 111, an assembly discussed further below, depresses to compress cartridge 122 and release collected matter. Screen 115 prevents cartridge 122 from reabsorbing high matter concentrate medium. The collected matter is then harvested from the Unit and subsequently used for commercial purposes. The Unit described in this paragraph contains optional features which are not intended to limit the scope of the claims, because the Unit, as one potential embodiment of a broader invention, is only offered to give context to the foregoing description.

### DETAILED DESCRIPTION OF THE DRAWINGS

### Material

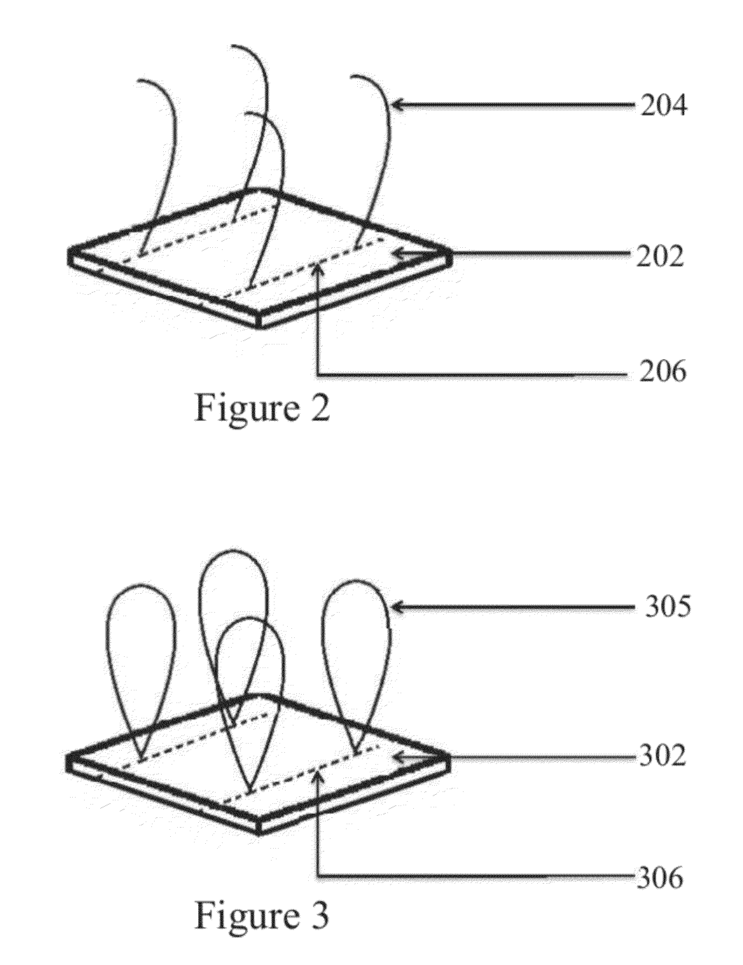

As shown in FIGS. 2 and 3, a material for collecting matter is comprised of at least a first surface 202 or 302 and a fiber. The fiber can be cut fiber 204 which is bound to the first surface 303, or the fiber can be a looped fiber which is bound to the first surface 302. The material can contain a combination of cut fibers 204 and looped fibers 305 which are bound to a common surface such as first surface 202 or 302. Cut fiber 204 and/or looped fiber 305 can be composed of a single filament or multiple filaments spun, twisted, braided or bunched to form substantially a single fiber such as a tuft, yarn, cord or rope.

Cut fiber 204 or looped fiber 305 ranges in length from 0.25″ to 12″ and more. More preferably, cut fiber 204 or looped fiber 305 is between 0.5″ and 3″, and an example preferred length of cut fiber 204 or looped fiber 305 is 1″. Spacing between a base of any two cut fibers 204 can range from 0.01″ to 7″ and more. More preferably, the spacing is 0.025″ to 1″, and an example preferred spacing distance of cut fiber 204 or looped fiber 305 is 0.05″. If cut fiber 204 or looped fiber 305 is a single filament, then the diameter of cut fiber 204 or looped fiber 305 can range from 0.0001 to 0.10″ and more, and an example of a preferred filament diameter of cut fiber 204 or looped fiber 305 is 0.0004″. If cut fiber 204 or looped fiber 305 is multifilament, then the diameter of that cut fiber 204 or looped fiber 305 is 0.005″ to 2″ and more, and an example of a preferred multifilament diameter of cut fiber 204 or looped fiber 305 is 0.15″. It should be noted that even if a multifilament cut fiber 204 or looped fiber 305 is composed of the same number and size individual filaments, cut fiber 204 or looped fiber 305 can have different diameters due to its method of processing, e.g., spinning, twisting or bunching. A bunched multifilament cut fiber 204 or looped fiber 305 would, everything else being equal, likely have more interstitial voids between fibers than twisted and maybe even more than spun and maybe even more than braided.

Cut fiber 204 or looped fiber 305 is constructed from at least one substance selected from the group comprising polystyrene, polyester, polyamide, polypropylene, polyethylene, vinyl, rayon, cotton, hemp, wool, silk, polyolefins, acrylic, nylon, flax, jute, glass, pina, coir, straw, bamboo, velvet, felt, lyocell, spandex, Kevlar, polyurethane, olefin, polyactide and carbon fibre, or any recycled products thereof, and cut fiber 204 or looped fiber 305, if multifilament, can be constructed from a blend of any of those listed. An example of preferable substances is nylon and polyester. If cut fiber 204 or looped fiber 305 is a natural fiber, then it can be manufactured in any process known in the art, such as by opening, carding, drawing, roving, spinning and/or twisting. If cut fiber 204 or looped fiber 305 is made from synthetic fibers, then it can be manufactured in any process known in the art, such as by extruding or spinning.

Cut fiber 204 or looped fiber 305 can be treated or processed to make it more or less oleophilic, oleophobic, hydrophilic and hydrophobic such as by adding or removing polymers known in the art which have the named properties. Examples of materials which are oleophilic comprise polypropylene, polyester, polyvinycholoride, steel or aluminum. Furthermore, materials with a combination of the listed properties is particularly advantageous if the material is preferential such as if a material is both oleophilic and hydrophilic but more oleophilic than hydrophilic. For example, integrating polyester may increase the oleophilic and hydrophilic nature of cut fiber 204 or looped fiber 305, but the cut fiber 204 or looped fiber 305 will be preferentially oleophilic. Although not intended to be limiting, if polyester material is with in an oil and water medium, then oil will collect preferentially over water; therefore, oil can be removed from the water and stored without removing the water from its environment. This advantage increases recovery rate of, e.g., an oil spill in aqueous medium. Furthermore, this permits the use of the material for tar sand or bitumen recovery after, e.g., water or steam is used to bring oil to the earth's surface. An oleophobic material, such as nylon or cotton, can be used to collect matter in a non-aqueous medium, such as oil, to lower levels of matter in the oil.

Cut fiber 204 or looped fiber 305 can be treated or processed to make it more or less conductive, such as by adding carbon or a polymer. Individual filaments of cut fiber can be processed to have any cross sectional shape from a circle, to a W or S shape, to a triangle, to a square, to a pentagon, to a hexagon, to an octagon, to star shaped. An example preferred embodiment is polyester in a circle or nylon in a W shape. Furthermore, individual filaments of cut fiber can be processed to have any longitudinal shape from a hair, to a W, X or S shape.

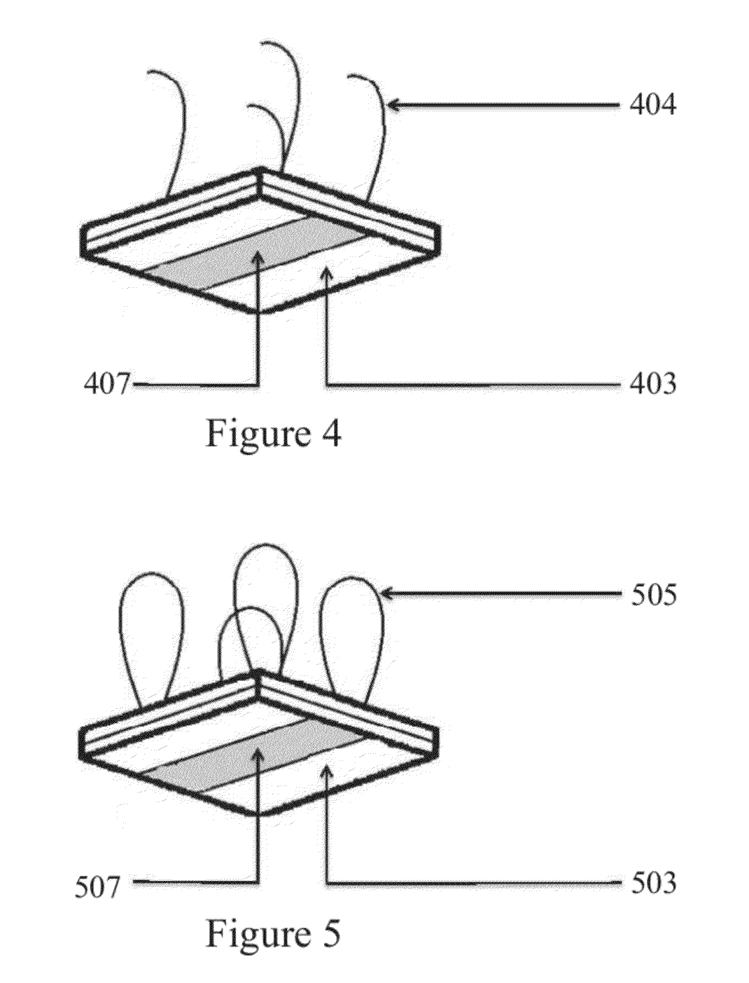

First surface 202 or 302 has a thickness as seen in FIG. 3 or 4, respectively, and that thickness can range from 0.01″ to 1.0″ and more. More preferably, first surface 202 has thickness between 0.02″ and 0.5″; an example preferred thickness of first surface 202 is 0.025″. As the surface area of first surface 202 or 302 increases due to increasing length and/or width of, e.g., a belt of material, the thickness of first surface 202 or 302 will likely increase to compensate for the increase in tensile forces exhibited during operation of the system for collecting matter. Alternatively, a second surface, as described below, can be attached to the first surface 202 or 302 to reduce strain on the first surface, in whole or in part.

First surface 202 or 302 can be constructed from any process known in the art which would make a planar surface from at least one substance selected from the group comprising polystyrene, polyester, polyamide, polypropylene, polyethylene, vinyl, rayon, cotton, hemp, wool, silk, polyolefins, acrylic, nylon, flax, jute, glass, pina, coir, straw, bamboo, velvet, felt, lyocell, spandex, polyurethane, olefin, polyactide, rubber, Kevlar, metallic mesh, carbon fibre, any blend of these and/or recycled products of these. An example of preferable substances is nylon and polyester. First surface 202 or 302 can be manufactured in any process known in the art, such as by weaving, knitting, tufting, spread tow, felting, thermal or mechanical bonding, extrusion, injection molding, compression molding or stamping.

Although the cut fiber 204 and looped fiber 305 are bound to their respective first surfaces, repeated extraction cycles could cause the fibers to disconnect from the first surface 202 or 302, and such disconnection could be detrimental to a material's collection rate. Therefore, the fibers, such as cut fiber 204 and looped fiber 305, can be further secured to the first surface by way of fiber reinforcement 206 or 306. Fiber reinforcement 206 or 306 are represented as dashed lines, because the fiber reinforcement can be integrated into the first surface 202 or 302, respectively, or on a portion of first surface 202 or 302 which is not visible given the particular view. Alternatively, fiber reinforcement 206 or 306 can be attached to the first surface such that cut fiber 204 or looped fiber 305, respectively, not only intersects the first surface and but also is reinforced by fiber reinforcement 206 or 306, respectively, at substantially the same point in space. Said attachment can occur with bonding by welding, adhering, stitching, laminating or any other process known by a person of skill in the art which can bond two or more surfaces together. Fiber reinforcement 206 and 306 can be manufactured from any synthetic or natural fiber which would increase the number of extraction cycles a fiber can endure without disconnecting from the first surface 202 or 302. An example of a preferred embodiment of a fiber reinforcement is a high twist multifilament nylon strand.

As shown in FIGS. 4 and 5, an example embodiment of a material for collecting matter further comprises a second surface 403 or 503 which is attached to a first surface, such as first surface 202 or 302 in FIGS. 3 and 4, respectively, of the material. Said attachment can occur with bonding by welding, adhering, stitching, laminating or any other process known by a person of skill in the art which can bond two or more surfaces together. Second surface 403 and 503 can provide additional features to the material which may not be provided, in whole or in part, by said first surface. Such additional features comprise improved tensile strength, increased or decreased flexibility or rigidity, increased or decreased coefficient of friction, e.g., configuring to an extractor or moving mechanism, increased or decreased buoyancy, and/or increased or decreased collection rates. In an example embodiment, a second surface 403 or 503 could be constructed of a foam which may cause, e.g., an increase in buoyancy, a reduction of drag in a medium, a reduction of belt friction on a moving mechanism. In an example embodiment, a second surface 403 or 503 could be another first surface complete with cut fibers and/or looped fibers which may, e.g., cause an increase in collection rate. In an example embodiment, a second surface 403 or 503 could be a polymeric sheet which may cause an increase or decrease in buoyancy depending on density, an increase in rigidity and increase in tensile strength. An example of a preferred embodiment of a second surface is a closed cell polyethylene foam which permits the material to reside at a boundary between a medium and the atmosphere. Another example of a preferred embodiment as a second surface is another first surface with cut fibers and/or looped fibers to create a double sided material.

As shown in FIGS. 4 and 5, an example embodiment of a material for collecting matter further comprises a surface reinforcement 407 or 507 attached to a surface of the material. Although the material has high a high tensile strength, repeated extraction cycles could cause a rupture in a surface of the material. Surface reinforcement 407 and 507 are shown as attached to second surface 403 and 503; however, surface reinforcement 407 and 507 could be attached to a first surface, such as first surface 202 or 302 in FIGS. 3 and 4, respectively, of the material regardless of whether second surface 403 or 503 exist. A surface reinforcement system could integrate into or with a fiber reinforcement system such that reinforcement of a fiber or a surface is achieved using the same reinforcement. Said attachment of the surface reinforcement 407 or 507 to a surface of the material can occur with bonding by welding, adhering, stitching, laminating or any other process known by a person of skill in the art which can bond two or more surfaces together. Surface reinforcement 407 or 507 can be any reinforcement material known to a person of skill in the art which could increase the tensile strength of a surface such as woven nylon, Kevlar sheets, extruded polymers, carbon nanotubes, metallic meshes and many others. An example of a preferred embodiment of surface reinforcement is a nylon seatbelt like material stitched to a distal surface of the material from which cut fibers and or looped fibers protrude, such as is seen in FIGS. 4 and 5.

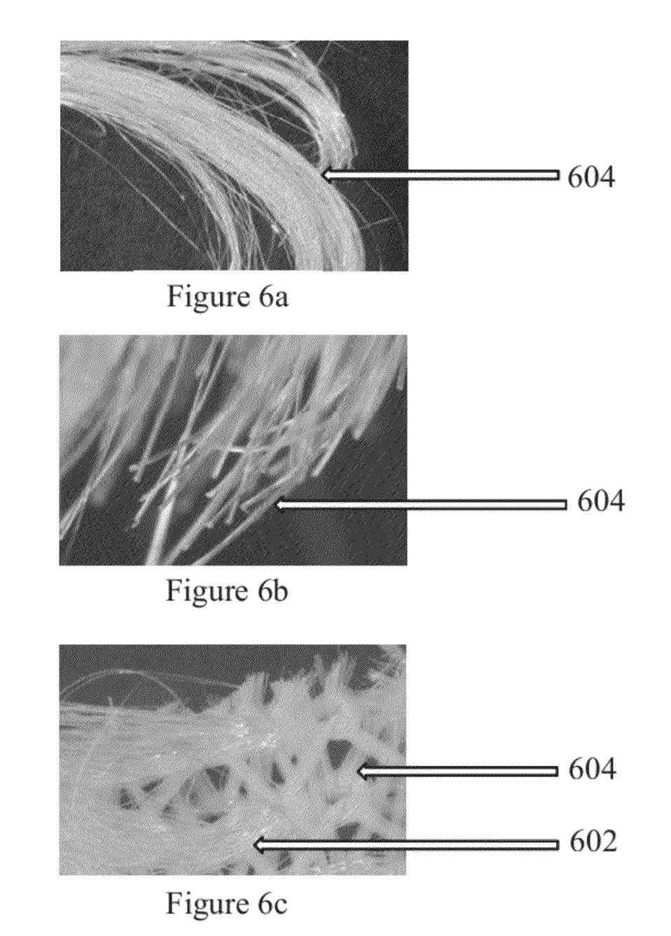

As shown in FIGS. 6a and 6b, an example embodiment of a cut fiber 604 is shown in increasing zoom. In this example embodiment, cut fiber 604 is a multifilament bunched fiber with a substantially circular cross section. FIG. 6c is an example embodiment of the cut fiber 604 and a first surface 602. The first surface 602 is a woven structure composed of multifilament wefts and warps with cut fiber 604 interlaced between said wefts and warps and projecting out from first surface 602.

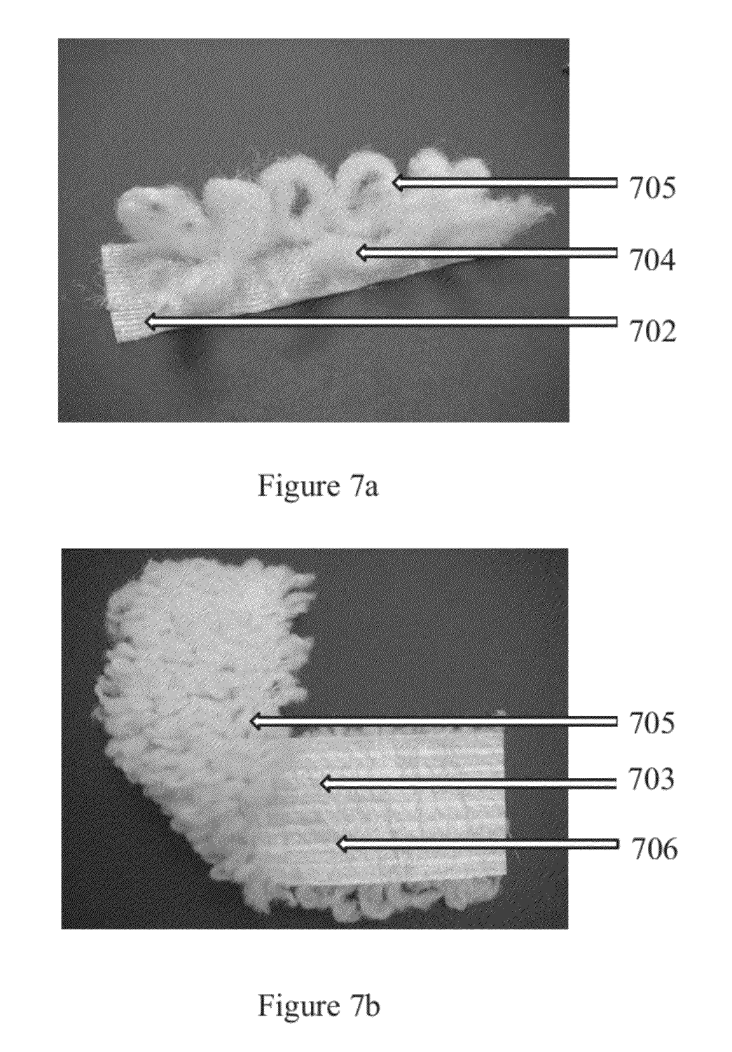

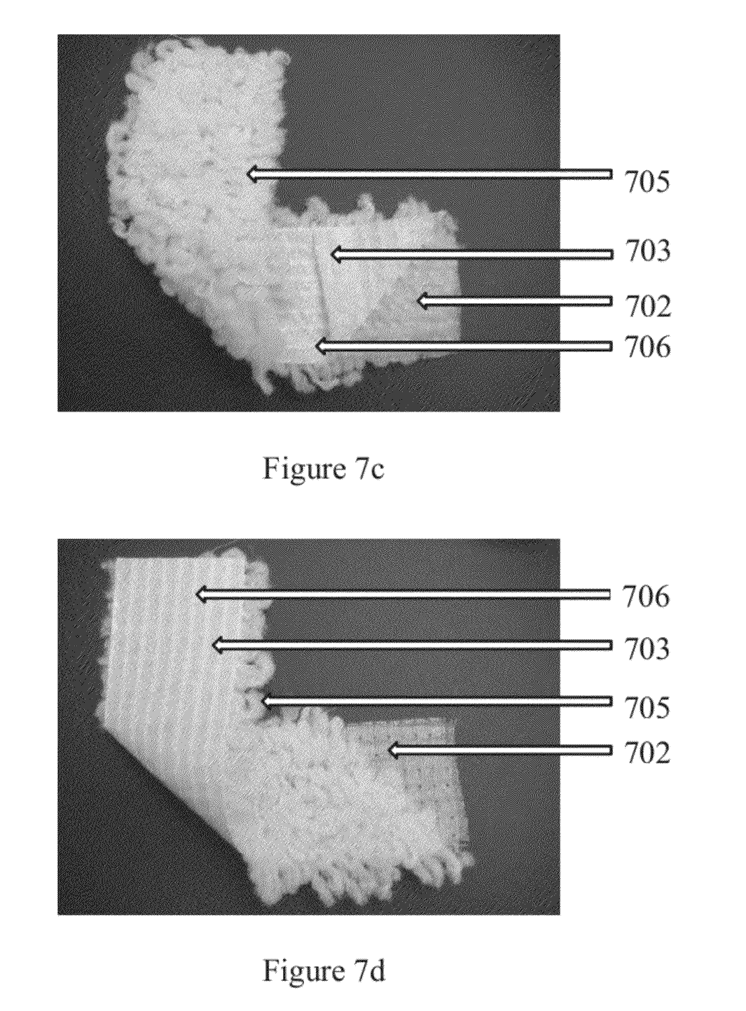

As shown in FIG. 7a, an example embodiment of a material for collecting matter is comprised of a first surface 702, a cut fiber 704 and a looped fiber 705. In this example embodiment, first surface 702 is constructed by weaving nylon straps having a width of 0.05″ and a thickness of 0.015″. Cut fiber 704 is a multifilament nylon wind protruding 1.5″ from the first surface, and an approximate diameter of cut fiber 704 is 0.25″. Looped fiber 705 is of the same construction as cut fiber 704, and looped fiber 705 protrudes 0.75″ from first surface 702. An approximate width of looped fiber 705, taking into account a central void formed by the looped fibers, is 0.75″. Spacing between any two cut fibers 704 and/or looped fibers 705 is between 0.5″ and 0.65″.

As shown in FIG. 7b, an example embodiment of a material for collecting matter is comprised of a looped fiber 705, a second surface 703 and a fiber reinforcement 706. Second surface 703 is constructed of a 0.15″ thick nylon sheet bonded to at least a first surface (not visible). Fiber reinforcement 706, which runs the length of the material, is a 0.15″ diameter nylon winding which is connected to looped fiber 705. As shown in FIGS. 7c and 7d, an example embodiment of a material for collecting matter is comprised of a looped fiber 705, a first surface 702, a second surface 703 and a fiber reinforcement 706.

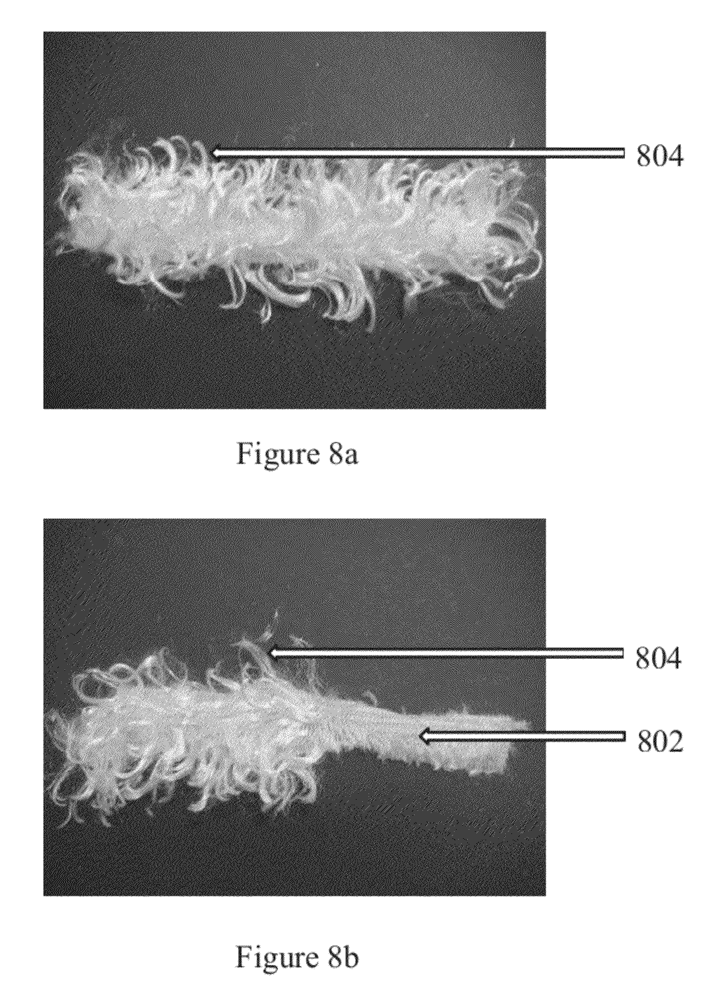

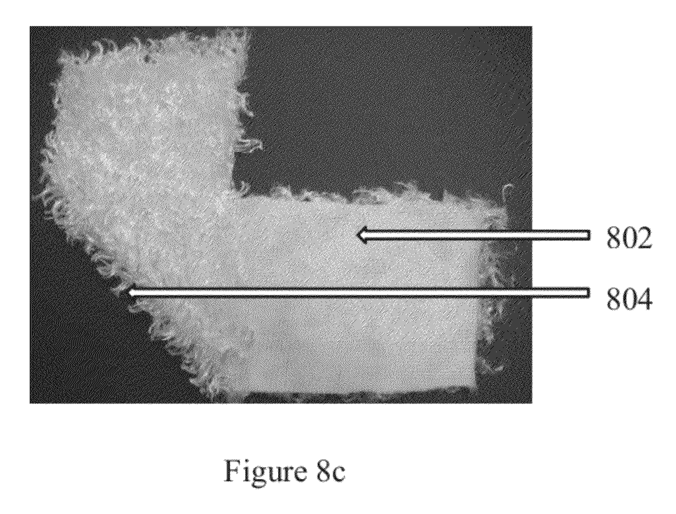

As shown in FIGS. 8a to 8c, an example embodiment of a material for collecting matter is comprised of a first surface 802 and a cut fiber 804. First surface 802 is a polyester weave comprised of a 0.010″ diameter multifilament thread. Cut fiber 804, which is anchored to first surface 802 by woven integration, is a 0.05″ diameter multifilament polyester wind protruding one inch from the first surface 802. Spacing between any two cut fiber 804 ranges between 0.010″ and 0.1″.

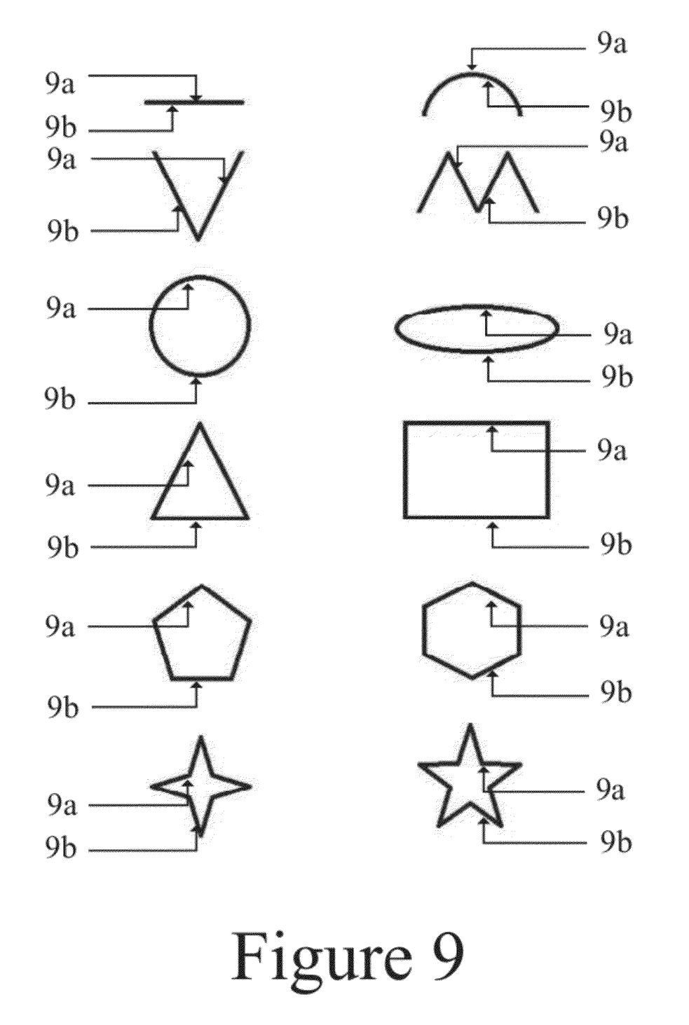

Example embodiments of a material for collecting matter discussed above represent the material as substantially planar; however and as shown in FIG. 9, a cross section of the material can take on any geometric shape having surface 9a and surface 9b. Surface 9a can be a first surface, as described above, and surface 9b can be second surface, as described above. Alternatively, surface 9a can be a second surface, and surface 9b can be first surface. Furthermore, surfaces 9a and 9b can have the same or different chemical and/or geometric structure. Surfaces 9a and 9b can be different surfaces of the same three dimensional object; therefore, either 9a and 9b are both a first surface or 9a and 9b are both a second surface.

If the combination of surfaces 9a and 9b form a closed geometric shape, then the internal void defined by the surfaces 9a and 9b can be filled with an object. That object can increase or decrease the buoyancy of the material. For example, stainless steel cables will decrease the material's buoyancy where as a closed cell polyethylene foam will increase the material's buoyancy. Furthermore, the object can be absorbent such that it will collect matter through absorption in addition to matter collected on material. In an example embodiment, the object is a polypropylene fiber and/or foam and the matter is oil. The closed geometric shape can be formed, e.g., by first taking a planar sheet of material, then folding it over and then joining the edges together. The exact geometric shape of such stitched material takes can be determined by, e.g., the shape of the inserted object. Alternatively, a first or second layer can be processed directly into any geometric shape, open or closed, by any known method in the art, such as stamping, crimping, extruding, injection molding, compression molding. In an example preferred embodiment, surface 9a is a first surface and surface 9b is a second surface. In another example preferred embodiment, a material for collecting matter has a cross sectional geometric shape that is substantially oval.

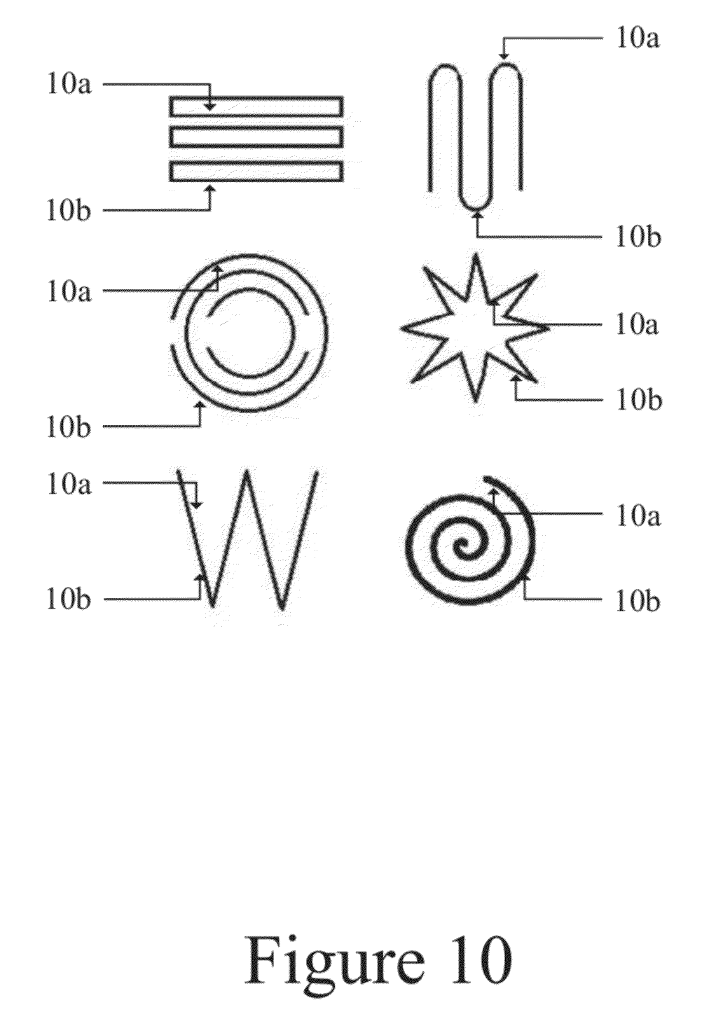

A planar material section of material can be used to form a cartridge having a cross sectional geometric shape of surface 9a and 9b as seen in FIGS. 9 or 10a and 10b as seen in FIG. 10. Surface 10a can be a first surface, as described above, and surface 10b can be second surface, as described above. Alternatively, surface 10a can be a second surface, and surface 10b can be first surface. Furthermore, surfaces 10a and 10b can have the same or different chemical and/or geometric structure. Surfaces 10a and 10b can be different surfaces of the same three dimensional object; therefore, either surfaces 10a and 10b are both a first surface or surfaces 10a and 10b are both a second surface.

### Collection

Although not intended to be a limiting statement, the matter may collect on the material by at least one process selected from the group of mechanically, chemically and electrically. A mechanical attraction could be, e.g., that a particle of matter becomes entangled by a fiber. A chemical attraction could be, e.g., that a chemical bond forms between a particle of matter and a fiber. An electrical attraction could be, e.g., that a particle carries an electrical charge which is substantially opposite to a charge present on a fiber's surface. matter may collect on a material in any combination of the aforementioned processes. Large quantities of matter can collect on material in the same manner as small quantities, but collection rate of matter may increase due to agglomeration of matter which may increase the surface area of the material which allows for more points of collection along the material's surface. Agglomeration could overtake other process of collection as a dominate process.

The process of collecting of matter is aided through material selection when considering the matter, the medium and the material. In an example embodiment, if a material is constructed of an oleophilic substance and matter to be collected is oil or a lipid containing organism, then the matter will be attracted to and collect on the material. In an example embodiment, if a material is constructed of an oleophilic substance with hydrophobic properties and a material to be collected is oil or a lipid containing organism in an aqueous medium, then the matter will be attracted to and collect on the material preferentially over the aqueous medium. Preferred embodiments of oleophilic and hydrophobic substances include polyester, polyethylene and polypropylene. In another example embodiment, if a material is constructed of a light conducting material and the matter to be collected is attracted to light, then the matter might collect on the material at an increased initial collection rate over non-light conducting material. The increased initial rate could quicken the point at which collection is dominated by agglomeration which will increase overall collection rate. An example embodiment of a light conducting material is an extruded polyester fiber which may conduct a light source's rays/beams which may then attract a photosynthetic organism, such as algae.

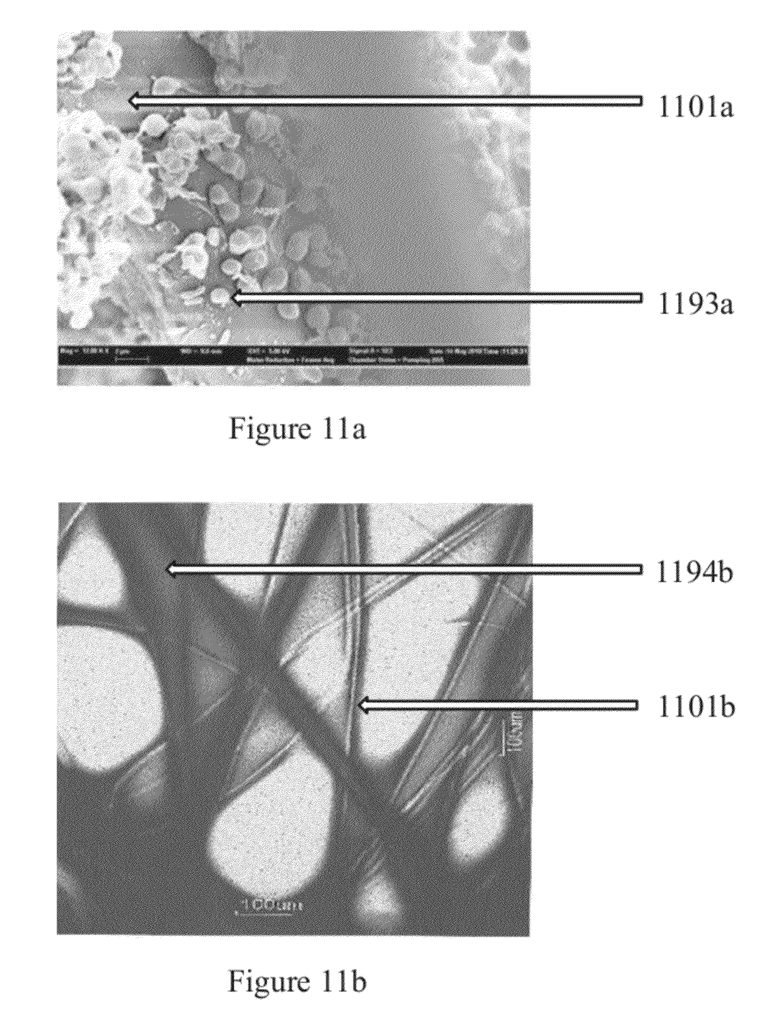

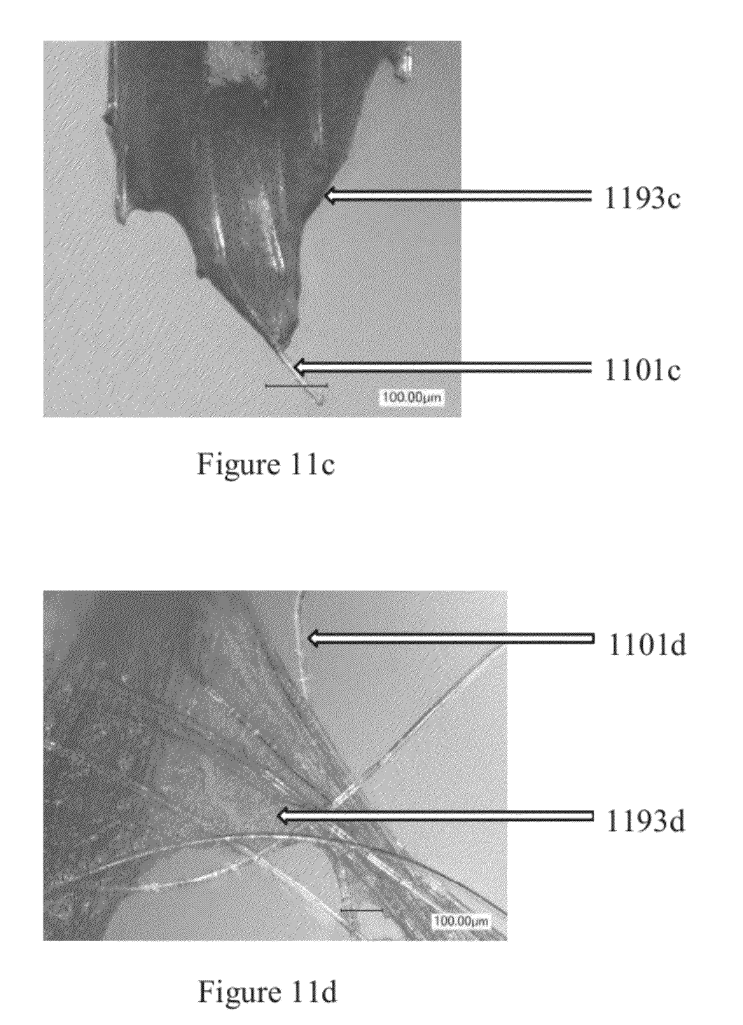

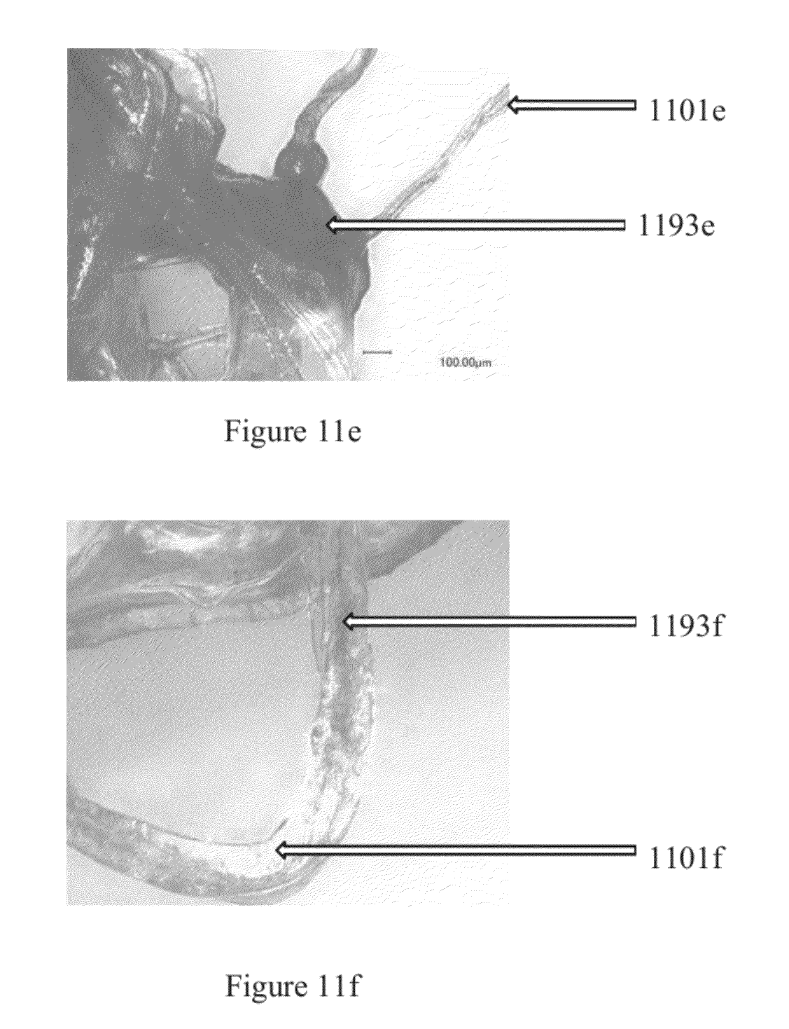

Although the following is not limiting to the invention, a collection can occur in different ways. As seen in FIG. 11a, collected matter 1193a, which is algae, is attached to a surface of material 1101a. The alga is approximately 2 μm in diameter, and it appears to be a discrete cellular body under high zoom. As seen in FIG. 11b, collected matter 1194b, which is oil, not only attaches to the material 1101b but also appears to create a continuous membrane which spans the distance between individual fibers of material 1101b. As seen in FIG. 11c, material 1101c protrudes from a bulb of collected matter 1193c, which appears to encapsulate a bunch of fibers comprising material 1101c. As seen in FIG. 11d, collected matter 1193 appears to form a web between fibers comprising material 1101d. As seen in FIG. 11e, collected matter is both forming a bulb around material 1101e and adhering to the surface of material 1101e. As seen in FIG. 11f, collected matter 1193f is seen adhering to the surface of material 1101f. The differing phenomenon is only discussed to exhibit visual differences in how matter and material mechanically interact at a micron level.

### Systems and Methods

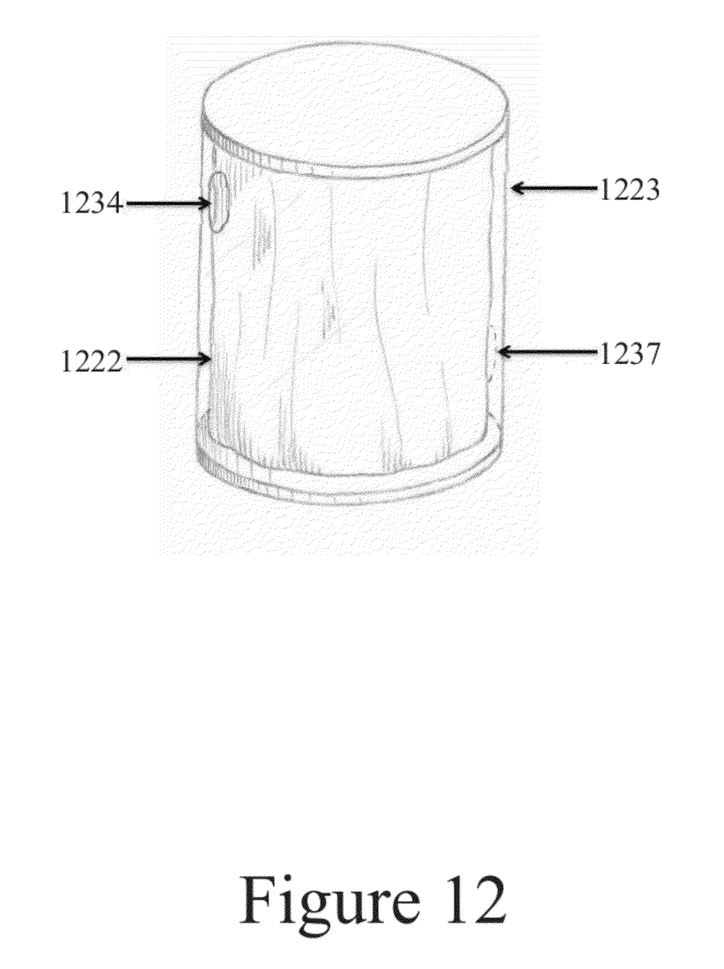

FIG. 12 shows a Unit that can be used with a method for collecting matter. The Unit is comprised of inlet port 1234 which is adapted to chamber 1223. Cartridge 1222 is disposed within chamber 1223, and outlet port is adapted to chamber 1223. Here, inlet port 1234 and outlet port 1237 are shown as substantially circular apertures in chamber 1223; however, inlet port 1234 and outlet port 1237 can be of any size, shape or number which is conducive to permitting a flow of a medium into the chamber through inlet port 1234 and out of the chamber through outlet port 1237. Suspended matter in the medium will collect on cartridge 1222 as the medium flows between inlet port 1234 and outlet port 1237. In another example embodiment, inlet port 1234 and outlet port 1237 can be located at a single aperture in chamber 1223 provided that the medium is able to come into contact with cartridge 1222. In another example embodiment of a port, chamber 1223 could have an open top, like a bucket or cup, where medium can flow into the chamber via the open top and such open top would be considered a port. That port could then also permit outflow of the medium via a spill over.

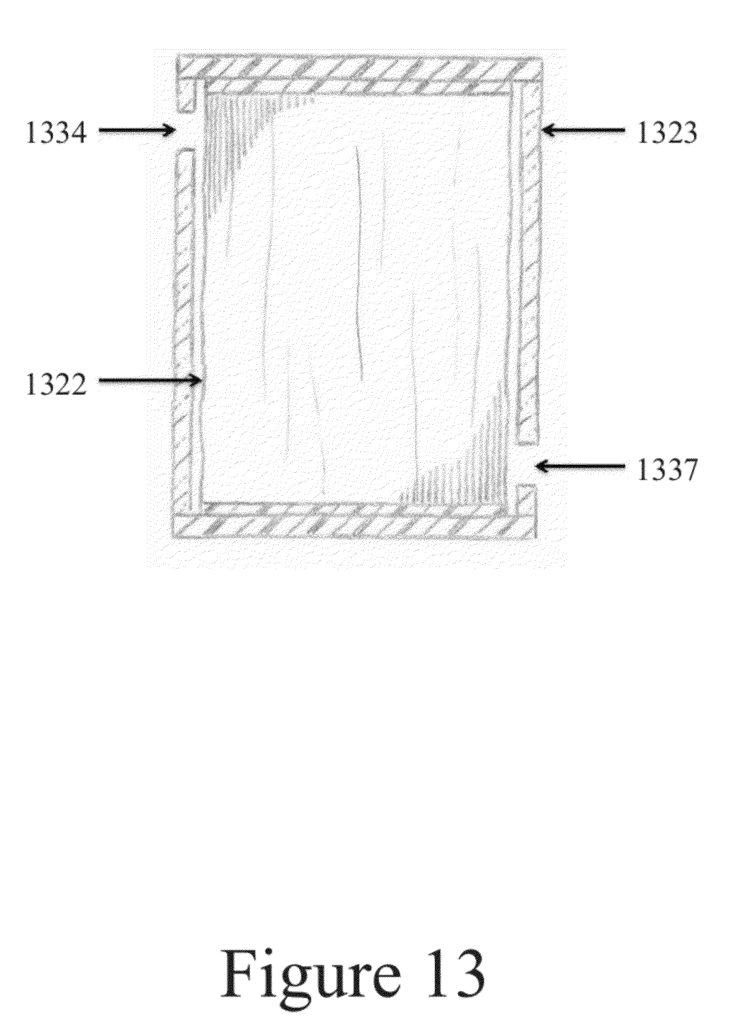

FIG. 13 shows a cross section of a Unit that can be used with a method for collecting matter. The Unit is comprised of inlet port 1334 which is adapted to chamber 1323. Cartridge 1322 is disposed within chamber 1323, and outlet port is adapted to chamber 1323. Chamber 1323 can be of any shape, size and material that is conducive to permitting a flow through chamber 1323. For example, chamber 1323 can have a cross sectional shape of a circle, triangle, rectangle, pentagon, hexagon, octagon, star and so forth. Chamber 1323 can have a diameter and/or height of between 6 inches and 30 feet and greater and preferably between 1 foot and 10 feet. Chamber 1323 can be constructed from any polymeric, composite or metallic material which is substantially non-reactive, medium impermeable and pressure resistive. Examples of such materials include polystyrene, polyester, polyamide, polypropylene, polyethylene, polyvinylchloride, polycarbonate, acrylic, nylon, polyurethane, carbon fibre, aluminum or steel. Chamber 1323 can be clear, translucent or opaque. Chamber 1323 preferably has low adhesive properties with collected matter.

Chamber 1323 can be a single piece construction or assembled from different pieces which are adapted together. For example, chamber 1323 can be a cylinder which has a detachable and/or permanently fixed base and/or cover. The base and cover can be of the same or a different material as the chamber, and the base, cover and chamber 1323 can be adapted to each other by any known method in the art, such as adhesives, threading, welding, interlocking or press fitting.

Options on size, shape and material of cartridge 1322 are discussed above; however, efficient collection of suspended matter is achieved when the cartridge substantially displaces a void within chamber 1323 such that the medium is forced into contact with the cartridge 1322 before exiting through outlet port 1337. Cartridge 1322 can be permanently or temporarily affixed to one or more portions of chamber 1323. Examples of methods of attachment include adhesives, fasteners, snaps, clips, bolts, Velcro, stitching, injection molding integration, interlocking pieces or any other method known in the art. Alternatively, cartridge 1322 can be merely disposed within chamber 1323 without any attachment. A temporary cartridge 1322 can be replaced by user such that a single Unit can have a longer useful life than one cartridge 1322. Cartridge 1322 can be sanitized by any known method in the art including heating, steaming, washing or rinsing with a cleaning fluid, and cartridge 1322 can be cleaned in place or after removal from chamber 1323. An example of cleaning in place would be to cycle a cleaning fluid or a hot liquid through the Unit in the same manner medium flow through the Unit. An example of cleaning after removal would be to decouple or extract the cartridge from the Unit and clean using any method known in the art, such as a washing machine or by hand.

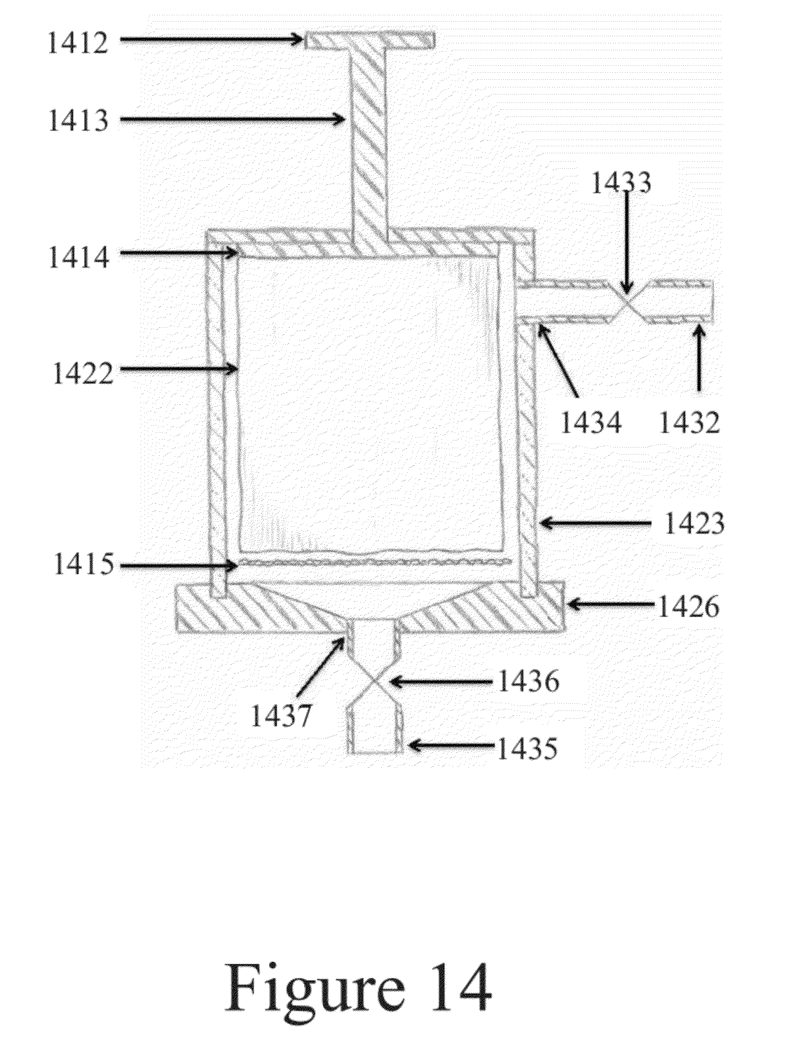

FIG. 14 shows a cross section of a Unit that can be used with a method for collecting matter. The Unit is comprised of inlet tube 1432, inlet valve 1433, inlet port 1434, chamber 1423, cartridge 1422, screen 1415, base 1426, outlet port 1437, outlet valve 1436, outlet tube 1435, pressure plate 1412, connection member 1413 and action plate 1414. A medium with suspended matter passes through inlet tube 1432, past open inlet valve 1433 and into chamber 1423 through inlet port 1434, and the suspended matter collects on cartridge 1422. The medium flows out of the Unit by passing through screen 1415 and outlet port 1437, and then through open outlet valve 1436 and outlet tube 1435. Both inlet tube 1432 and outlet tube 1435 are adapted to both sides of inlet valve 1433 and outlet valve 1436, respectively. Therefore, inlet tube 1432 and outlet tube 1435 enter the Unit at inlet port 1434 and outlet port 1437, respectively, and inlet tube 1432 and outlet tube 1435 can be adapted to the Unit in any manner known in the art, such as welding, threading, interlock or adhering. Inlet tube 1432 and outlet tube 1435 can be constructed of any material known in the art to transfer a medium and is capable of adapting to chamber 1423, inlet valve 1433, outlet valve 1436 and base 1426.

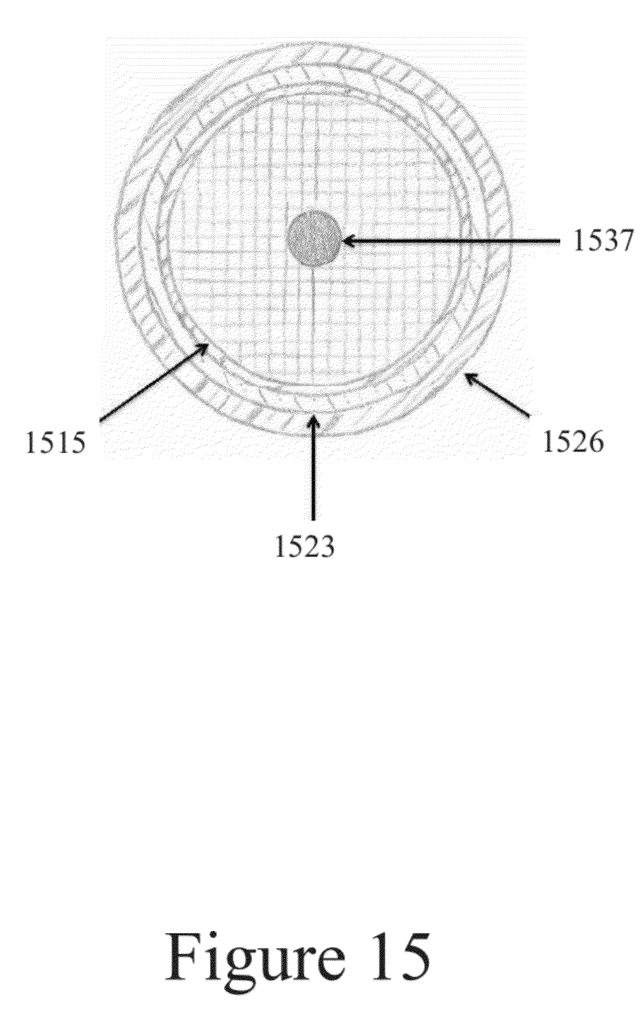

The Unit of FIG. 14 has base 1426 instead of being constructed from a single piece as seen in FIG. 15. Therefore, outlet port 1437 is an aperture in base 1426 instead of chamber 1423. Base 1426 can be constructed from any material that chamber 1423 can be constructed from, and base 1426 has a diameter which is at least equal to the inner diameter of chamber 1423. Base 1426 can be any shape; however, if base 1426 is designed to fit completely inside chamber 1423, then base 1426 would have to be substantially the same shape as chamber 1423 to prevent medium leakage. Here, base 1426 has a channel which interlocks with chamber 1423 to provide stability and seal the unit; however, base 1426 and chamber 1423 can be joined in any permanent or temporary manner, such as welding, threading, interlocking or adhering. An optional feature of base 1426 is a conical boring on a surface facing the internal void of chamber 1423. The boring more easily allows the medium to flow out of chamber 1423.

FIG. 15 shows a cross section of a Unit can be used with a method for collecting matter. For reference, the cross sectional view shows outlet port 1537 from the inside of chamber 1523. Base 1426 is seen as slightly larger in diameter than chamber 1523. Screen 1515 is shown as a grid formed from thin elements; however, screen 1515 can be a plate with holes or any other structure which permits medium and collected matter to pass through. A primary function of screen 1515 is to prevent a cartridge (not visible) from making contact a bottom surface of the Unit, here seen as base 1526, such that a void exists between screen 1515 and base 1526. The void permits efficient drainage of collected matter through outlet port 1537. Screen 1515 can be constructed from metallic or polymeric materials, and screen 1515 should be a non-reactive, high tensile strength and a material which will not absorb the medium and/or collect matter. Screen 1515 can be permanently or temporarily adapted to chamber 1523 in any manner known in the art, such as fastening, welding, threading, clipping, interlocking or adhering. Alternatively, screen 1515 can abut against a ledge (not shown) projecting outward from an inside surface of chamber 1523. Alternatively, screen 1515 can contain posts (not shown) which abut against a surface of base 1526. Screen 1515 can be of any shape and size which fits inside chamber 1523, permits medium and collected matter to flow through and substantially prevents a cartridge (not shown) from passing through.

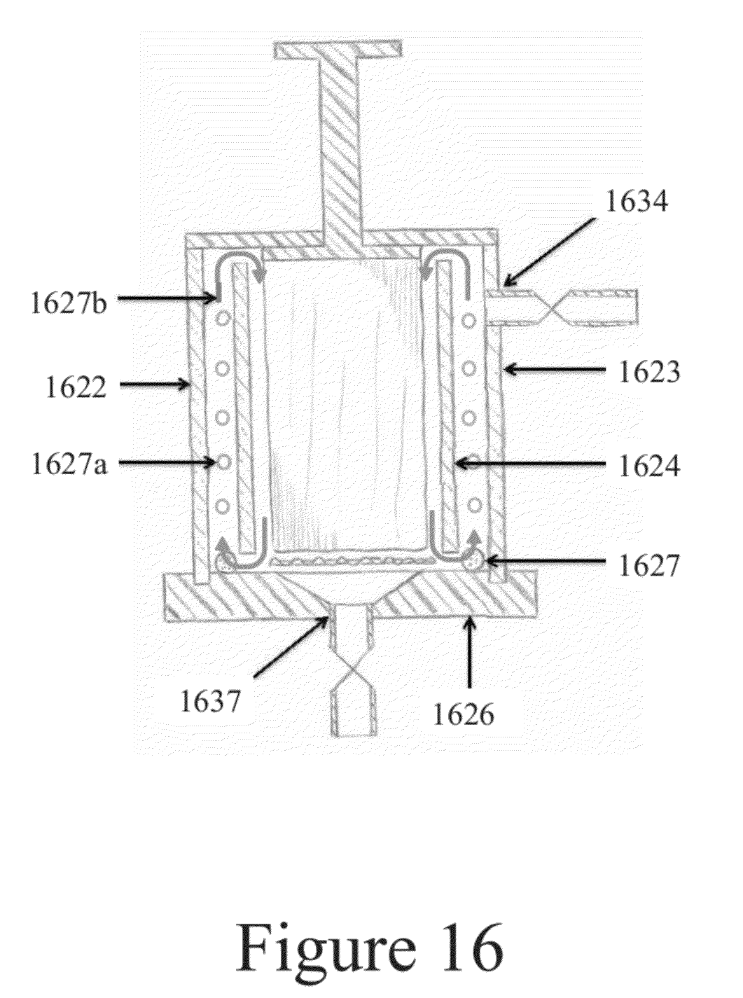

FIG. 16 shows a Unit that can be used with a method for collecting matter; additional/optional equipment which may improve the Unit's efficiency is shown. The Unit is comprised of chamber 1623, duct 1624 and bubbler 1627. Cartridge 1622 is disposed within duct 1624. Duct 1624 is disposed within chamber 1623 such that a void is between an outer surface of duct 1624 and an inner surface of chamber 1623. Bubbler 1627 is interposed between duct 1624 and chamber 1623. Bubbler 1627 emits bubbles 1627a which cause bubbler flow 1627b around the duct as represented by arrows. Bubbler flow 1627b causes suspended matter in the medium to pass by cartridge 1622 more than the suspended matter might otherwise if no bubbler existed. Bubbler 1627 can be fed a gas to create bubbles 1627a in any manner known in the art, such as by running a line through an inlet port 1634, outlet port 1637 or by adapting a new port in chamber 1623 or base 1626.

The size and shape of duct 1624 should substantially match that of chamber 1623 and/or cartridge 1622; however, enough room needs to exist between chamber 1623 and duct 1624 so that the medium can flow around the duct. Duct 1624 can have a diameter and/or height which is between 10 and 99% that of chamber 1623. Duct 1624 can have a diameter and/or height which is between 100% and 1000% that of cartridge 1622. Duct 1624 can be made of a same or different material as chamber 1623, discussed above. Duct 1624 need not be pressure resistive; duct 1624 could be non-reactive. Duct 1624 can sit inside chamber 1623 using posts (not shown) that abut against base 1626, or duct 1624 can interlock with base 1626 in the same manner as chamber 1623 as seen in FIG. 16 or temporarily or permanently attach in any many known in the art. Alternatively duct 1624 can have supports (not shown) which abut against chamber 1623. Those supports can be temporarily or permanently affixed to chamber 1623 by fastening, compressing, interlocking, welding, adhering, clipping or using friction.

Advantage of using a bubbler 1627 and duct 1624 comprise decreased energy requirements for a flow of medium, increasing medium circulation to increase collection and injecting a chemical, e.g. carbon dioxide, which algae can use for photosynthesis. Bubbler 1627 and duct 1624 could also prevent suspended matter from collecting near base 1626. Bubbler 1627 can increase an amount of time suspended matter stays in the Unit, such that the suspended matter is more likely to come in contact with and collect on cartridge 1622.

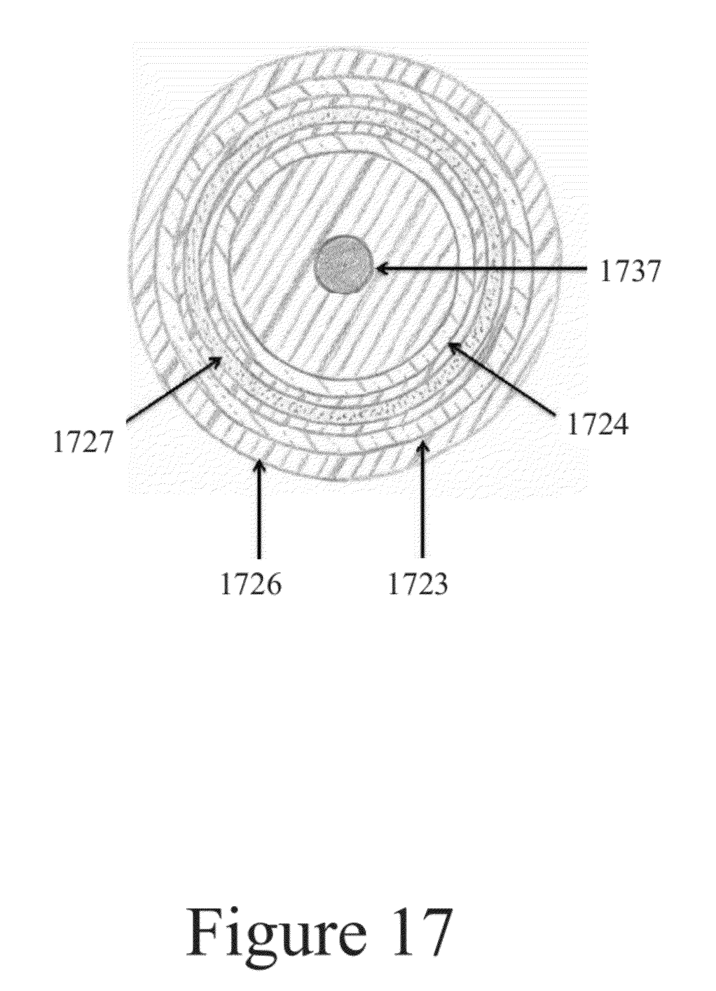

FIG. 17 shows a cross section of a Unit can be used with a method for collecting matter. For reference, the cross sectional view shows outlet port 1737 from the inside of chamber 1723. Bubbler 1727 is seen as a tube extended along a perimeter formed where chamber 1723 and base 1726 intersect, but bubbler 1727 need not extend the entire perimeter. Bubbler 1727 is interposed between duct 1724 and chamber 1723.

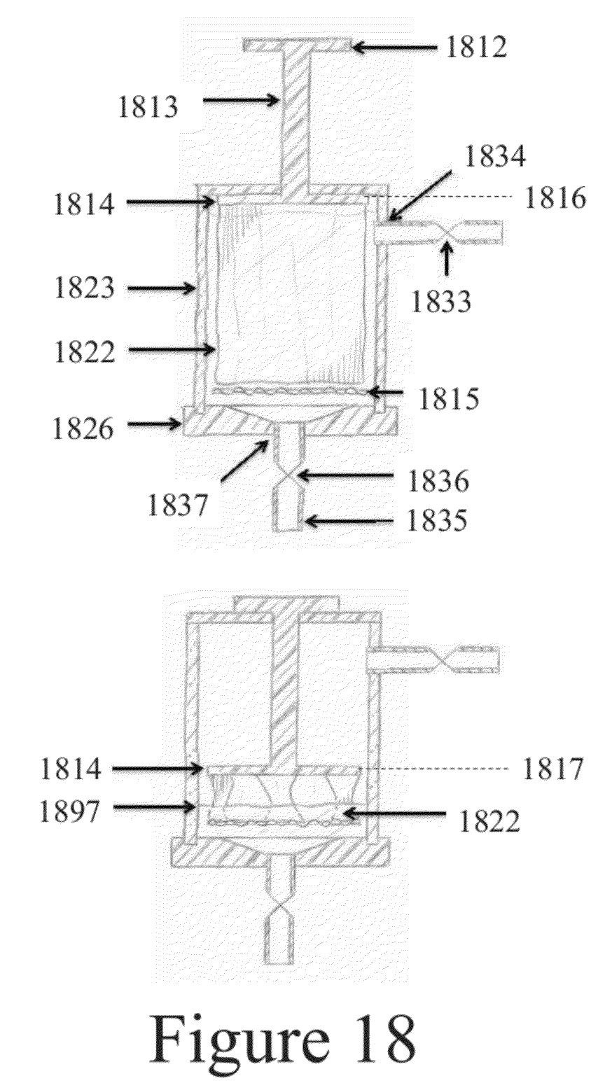

FIG. 18 shows a method for collecting matter using a matter collection Unit. A material for collection matter, comprised of at least a first surface and a fiber, is formed into a cartridge 1822 and disposed within a provided chamber 1823. Inlet port 1834 and outlet port 1837 are adapted to the Unit at chamber 1823 and base 1826, respectively. A medium with suspended matter is permitted to flow through inlet port 1834 to the interior of chamber 1823. Suspended matter collects on cartridge 1822, and medium flows out of the unit through outlet port 1837.

FIG. 18 also shows a method for extracting matter using a matter collection Unit. The flow of medium into the Unit at inlet port 1834 ceases by closing inlet valve 1833. The medium is permitted to continue to flow out of the Unit at outlet port 1837. Extraction occurs by applying a force to pressure plate 1812; the force is translated by connection member 1813 which causes motion in action plate 1814 from a first position 1816 to a second position 1817. Cartridge 1822 is adapted to action plate 1814 in any manner that cartridge 1822 could be adapted to the Unit and/or chamber 1823, as discussed above. Such adaptation causes cartridge 1822 to move with action plate 1814. Action plate 1814 compresses cartridge 1822; such compression causes cartridge 1822 to release matter collected. Cartridge 1822 can be compressed multiple times in one extraction cycle. The collected matter exits the chamber by passing through screen 1815 and out of the Unit through outlet port 1837. The collected matter can be diverted to a container (not shown) for storage. Diversion can occur through operation of outlet valve 1836 such that another tube (not shown) is engaged for permitting flow when outlet valve 1836 obstructs flow through outlet tube 1835.

In an alternative process, outlet valve 1836 is closed so that a small amount of medium is retained within chamber 1823 to an approximate medium level 1897. The retained medium can be used to wash cartridge 1822 and remove more collected matter than might otherwise be removed through just compression. Furthermore, if medium is drained off slowly, then matter which has loosely or weekly collected on the cartridge will have a higher likelihood of remaining collected instead of draining off and returning to a medium body. Cartridge 1822 can also be twisted at, during or before reaching second position 1817 by twisting pressure plate 1812; such twisting may remove more collected matter than might otherwise be removed through just compression. Medium can also be added to chamber 1823 by, e.g., throttling inlet valve 1833, to wash cartridge 1822 which could further increase extraction efficiency

Inlet valve 1833 and outlet valve 1836 can be any type of mechanism, as discussed above, known in the art used to constrict, regulate or prevent a flow of medium, and inlet valve Timing the opening and closing can be done manually or automatically, such that the Unit can operate with minimal human interaction.

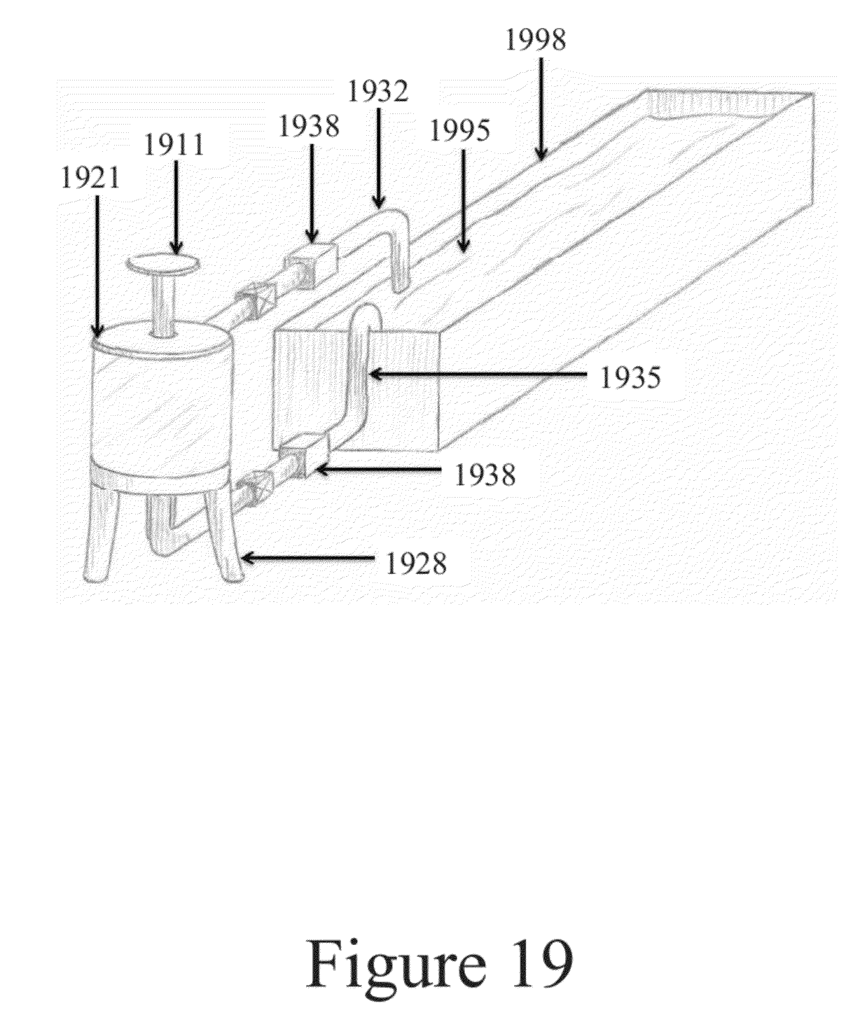

FIG. 19 shows a process for extracting matter using a matter collection Unit. Unit 1921, as described in detail above, is adapted to a medium body 1998, as defined above, to collect suspended matter in medium 1995. FIG. 19 shows two pumps 1938, but one or more pumps can be used in the matter collection process. The medium flows into Unit 1921, positioned on stand 1928. Suspended matter collects on a cartridge (not shown) disposed within Unit 1921. Medium flows out of the Unit and returns to medium body 1998 through outlet tube 1935. After matter is collected, pump 1938 can be shut off, and extractor 1911 can be used to extract collected matter. The collected matter is diverted to a container (not shown) for storage. Alternatively, collected matter can be diverted to a solid liquid separator, e.g. an SLS offered for sale by Algaeventure Systems, Inc. of Marysville, Ohio, USA, for a subsequent dewatering processes.

Pump 1938 creates a differential pressure which permits a flow of medium through inlet tube 1932 out of medium body 1998. Generally, collection rate is proportional to flow rate; however, collection rate decreases when flow through the Unit causes collected matter to de-collect from a cartridge (not shown) due to highly turbulent flow. Flow rate is dependent on many factors, including the size of Unit 1921 and medium body 1998. If the medium body is an algal growth system, then the flow rate can be matched to the algal growth so that algae is harvested from a growth system at the same rate that the algae can grow, preferably when algae is at its exponential growth rate.

Pump 1938 is an optional component of the process, because medium 1995 can be permitted to flow through Unit 1921 by using a flow already existing in medium body 1998. For example, if medium body 1998 is a natural body of water with its own flow, due to currents or tides, then that flow could be used to circulate medium through Unit 1921. Natural bodies of water contain more than just suspended matter, e.g. litter and macro aquatic life; therefore, a filter can be used on conjunction with an inlet port to prevent fouling of the Unit with litter, e.g. Alternatively, processes such as introducing ozone, UV light, electricity, cross flow filters and membrane filters, can reduce contamination of collected matter by organisms. If medium body 1998 is a raceway, then an induced circulation of medium can be utilized allow medium 1995 to flow through Unit 1921. In such an embodiment, Unit 1921 could be inserted into the raceway such that inlet tube 1932 and/or outlet tube 1935 is not necessary. Medium enters the Unit directly through an inlet port shaped, e.g., like a slot or grill shaped aperture. A user can pull the Unit out of the medium body and subsequently extract. The Unit can be an apparatus to close of the inlet port so that collected matter is not lost prior to extraction; such an apparatus could be, e.g., a slider or cover or cap which is moved into place to obstruct any ports. If a Unit is disposed within a medium body, then the Unit can have movement means, such that it can travel through the medium and collect matter. Movement means can be any device known in the art to propel an object through a medium, such as wheels, tracks or a propeller.

In an alternative embodiment, outlet tube 1935 can be adapted to Unit 1921 in manner such that outlet tube 1935 acts as an overflow tube. Such a construction would mean that an outlet valve and a pump is not necessary. This could also simplify the extraction process

Extractor 1911 can be any type of mechanism, as discussed in detail above, known in the art used to extract matter from a material, and extractor 1911 can be operated manually, mechanically and/or electronically. Timing the opening and closing can be done manually or automatically, such that the Unit can operate with minimal human interaction.

Unit 1921 can be fitted with any device known in the art to permit transport or movement of Unit 1921 from one location to another; such devices comprise handles, wheels, slots, hooks and castors. Unit 1921 can move from one medium body 1998 to another medium body 1998 such that an algae grower can have one Unit 1921 for several growth systems. Multiple Units can be operated in parallel or in series to maximize matter collection efficiency.

The length of a dwell period can be determined in a variety of ways. A simple method is to determine a fixed time, and that time can take into account different factors: pump flow, cartridge surface area, chamber diameter and suspended matter concentration. If suspended matter has a color which differs from that of the cartridge and the color intensity and/or opacity increases with increased collection, then optical measurements can be used to determine when an extraction process is necessary. For example, if a particular strain of algae reflects a narrow range of electromagnetic wavelengths when at a specific concentration, then using an optical sensor to start extraction when the wavelength is reached can be used. In another example, an electromagnetic beam can be reflected off of a surface and collected by an optical sensor; if the beam's intensity drops below a certain point, then the extraction process can begin. Suspended matter has mass; therefore, changes in weight of a cartridge can be used to determine when a cartridge is ready for extraction. Adapting a measuring device, e.g. a graduated cylinder, with the chamber can provide a visual indicator of readiness based on how much suspended matter collects in the device. Collected matter can change the medium's or the cartridge's capacitance and/or conductivity; therefore, electrical charge can be used to determine when a cartridge is ready. Any of these methods can be manual, such that a user must take a reading and then start a process, or automatic, such that the Unit reacts to start the extraction process in response to a sensor. Additionally processes can occur in a Unit, such as sonication to separate solids from lipids and lipid boosting.

### EXAMPLE

A swatch of material was cut from cut fiber material made from polyester. The material had a first surface with a thickness of 0.0254 cm. The cut fibers were multifilament bunches having an individual filament diameter of approximately 0.0013 cm and a bunch diameter of approximately 0.076 cm. Spacing between bunches ranged from 0.013 cm to 0.3 cm. The material was folded over into a double sided material and stitched along an edge to form a surface area of 1.75 m² and weighing approximately 840 grams. The material was formed into a cartridge 38.1 cm high with a radius of 13.65 cm. The cartridge was disposed within an acrylic cylindrical duct having an inner diameter of 27.3 cm, wall thickness of 0.3175 cm and height of 38.1 cm. The duct was disposed within an acrylic cylindrical chamber having an inner diameter of 29.85 cm, wall thickness of 0.3175 cm and height of 38.1 cm. A bubbler was interposed between the duct and chamber. A 5.1 cm thick nylon base was milled to adapt to the chamber, the duct and an outlet port, and the pieces where then fitted and sealed to the base. A stainless steel screen was attached to the base inside the duct using screws. A plunger type extractor was fitted to the duct using a cover, and an inlet port manifold with four 0.95 cm inlet tubes was adapted to the cover. The plunger was adapted to the cartridge. An outlet port was fitted to the chamber such that overflow medium waterfalls into a medium body. The tubes were fitted to a pump set to flow at 19 gallons per hour. The pump pumped medium from a medium body having a volume of 993 liters with an algal concentration of 0.14 grams per liter. The bubbler bubbles air into the chamber at a rate between 2.3 and 7 cfm. The cartridge had a dwell time of 24 hours, and then the pump was shut off and inlet valve closed. Medium was slowly drained out of the Unit until only a few centimeters remained, and then an outlet valve was closed. An outlet tube was positioned over a container, and the plunger was depressed. An oscillatory motion was used to extract collect matter, and the retained medium washed the cartridge, further increasing collection. The collected matter exited the unit through the outlet port, outlet tube and open outlet valve. A mixture of collected matter and retained medium, 15 liters had a concentration of 8.65 grams per liter. The medium body, prior to collection, had 139 grams of algae in 993 liters of water, and the Unit collected 129 grams of algae for a collection efficiency of 93% on with a pump using between 3.9 to 5 watts of energy.

The previously described embodiments of the present invention have many advantages, including processes that satisfy the need for a low initial, operating and downstream cost while being a contaminant free and a non-damaging process for collecting matter suspended and/or dissolved in a liquid medium. Embodiments of the invention do not need to incorporate all advantages that the invention achieves over prior art.

Having shown and described embodiments of the invention, those skilled in the art will realize that many variations and modifications may be made to affect the described invention and still be within the scope of the claimed invention. Thus, many of the elements indicated above may be altered or replaced by different elements which will provide the same result and fall within the spirit of the claimed invention. It is the intention, therefore, to limit the invention only as indicated by the scope of the claims.

What is claimed is:

1. A method of collecting matter, the method comprising the steps of
a) providing a material for collecting matter, wherein the material has at least
i. a first surface and
ii. a fiber,
b) providing a medium with suspended matter, and
c) permitting a flow of the medium.

2. The method of collecting matter of claim 1, further comprising the steps of
a) providing a matter collection unit comprised of at least a chamber,
b) forming the material for collecting matter into a cartridge,
c) disposing the cartridge in the chamber,
d) adapting at least one port to the unit,
e) directing the flow of medium into the unit through at least one port.

3. The method for collecting matter of claim 2, further comprising the step of adapting the unit to a growth system.

4. The method for collecting matter of claim 2, further comprising the step of adapting at least a tube to the unit.

5. The method for collecting matter of claim 2 further comprising the step of adapting at least a valve to the unit.

6. The method for collecting matter of claim 2 further comprising the step of adapting a base to the unit.

7. The method for collecting matter of claim 2, further comprising the step of adapting a screen to the unit.

8. The method for collecting matter of claim 2, further comprising the steps of
a) providing an extractor, and
b) adapting the extractor to the unit.

9. The method for collecting matter of claim 2, further comprising the steps of
a) providing a duct, and
b) interposing the duct between the chamber and the material.

10. The method for collecting matter of claim 9, further comprising the steps of
a) interposing a bubbler between the chamber and the duct, and
b) permitting a flow of a gas through the bubbler.

11. A system for collecting matter, the system comprising
a) a material for collecting matter, wherein the material has at least
i. a first surface and
ii. a fiber,
b) a medium, and
c) matter.

12. The system for collecting matter of claim 11, further comprising a matter collection unit comprised of
a) a chamber,
b) a cartridge comprising the material for collecting matter, and
c) at least one port.

13. The system for collecting matter of claim 12 further comprising at least one of the following characteristics:
a) the material is at least one selected from the group comprising polystyrene, polyester, polyamide, polypropylene, polyethylene, vinyl, rayon, cotton, hemp, wool, silk, polyolefins, acrylic, nylon, flax, jute, glass, pina, coir, straw, bamboo, velvet, felt, lyocell, polyurethane, olefin, polyactide and carbon fibre;
b) the fiber is at least one selected from the group comprising a cut fiber and a looped fiber;
c) the material further comprises at least one selected from the group comprising a second surface, a reinforcement fiber and a surface reinforcement; and,
d) the medium is at least one selected from the group comprising fresh water, brackish water, salt water, marine water, briny water, commercial waste water, residential waste water, agricultural waste water, growth system water.

14. The system for collecting matter of claim 12, wherein the matter is at least one selected from the group comprising algae, oil, bacteria, silt, sand, ethane, hexanol, nitrates, phosphates, benzene, lead, mercury, cadmium, iron, aluminum and arsenic.

15. The system for collecting matter of claim 12 further comprising a growth system.

16. The system for collecting matter of claim 12, wherein the port is at least one selected from the group comprising an inlet port and an outlet port.

17. The system for collecting matter of claim 16, wherein the unit further comprises at least one selected from the group comprising an inlet tube and an outlet tube to the unit.

18. The system for collecting matter of claim 16, wherein the unit further comprises at least one selected from the group comprising an inlet valve and an outlet valve to the unit.

19. The system for collecting matter of claim 12, further comprising an extractor, wherein the extractor is at least one selected from the group comprising a plunger, a piston, a screen, an orifice, a belt roller, a nested roller, a funnel, a vacuum, a scraper, an electric charge, an air knife, a spinner, a sonicator, a vibrator, a human hand, a heater, a steamer and a low-volume high pressure sprayer.

20. The system for collecting matter of claim 12, further comprising at least one of the following:
a) a base;
b) a screen;
c) a duct; and,
d) a bubbler.
